(19) United States
(12) Patent Application Publication
(10) Pub. No.: US 2012/0269498 A1
(43) Pub. Date: Oct. 25, 2012

(54) UNIT FOR SUPPORTING A SUBSTRATE AND APPARATUS FOR TREATING A SUBSTRATE WITH THE UNIT

(75) Inventors: Gonsu KANG, Hwaseong-si (KR); Sangbom KANG, Seoul (KR); Jaeyoung PARK, Yongin-si (KR); Sungho KANG, Hwaseong-si (KR); Taegon KIM, Seoul (KR); Hyunsub EARM, Hwaseong-si (KR); Jong-hoon KANG, Seoul (KR); Kang Hun MOON, Osan-si (KR); Han Ki LEE, Hwaseong-si (KR)

(73) Assignee: SAMSUNG ELECTRONICS CO., LTD., Suwon-si (KR)

(21) Appl. No.: 13/452,052

(22) Filed: Apr. 20, 2012

(30) Foreign Application Priority Data
Apr. 22, 2011 (KR) 10-2011-0037964

(51) Int. Cl. F27D 5/00; F26B 3/30

(52) U.S. Cl. 392/418; 432/259; 392/416

(57) ABSTRACT

A substrate treatment apparatus and a supporting unit are provided. The substrate treatment apparatus includes a chamber in which a substrate is processed; a supporting unit that is disposed in the chamber and is configured to support the substrate; and a heating member that is configured to apply heat to the substrate supported by the supporting unit. The supporting unit includes a plate; a plurality of supporting pins upwardly protruding from the plate; and at least one auxiliary pin upwardly protruding from the plate. A distance between a central point of the plate and the at least one auxiliary pin is different from a distance between the central point of the plate and the supporting pins.

### CROSS-REFERENCE TO RELATED APPLICATIONS

This application claims priority from Korean Patent Application No. 10-2011-0037964, filed on Apr. 22, 2011, the entirety of which is incorporated by reference herein.

### BACKGROUND

1. Technical Field

The present disclosure relates to an apparatus for treating a substrate and, more particularly, to units for supporting a substrate and an apparatus for thermally treating a substrate with the unit.

2. Description of Related Art

In general, an annealing process for heating a substrate may be performed to activate impurity ions in a semiconductor wafer using a flash lamp after ion implantation process. Recently, a flash annealing apparatus has been used to rapidly increase a surface temperature of the wafer within a short period of about several milliseconds using a flash lamp during the annealing process.

A general flash annealing apparatus has a supporting unit on which the wafer is loaded.

### SUMMARY

Exemplary embodiments provide units for supporting a substrate and an apparatus for thermally treating a substrate with the unit.

According to an aspect of an exemplary embodiment, there is provided an apparatus including a chamber in which a substrate is processed, a supporting unit that is disposed in the chamber and is configured to support the substrate, and a heating member that is configured to apply heat to the substrate supported by the supporting unit. The supporting unit includes a plate, a plurality of supporting pins upwardly protruding from the plate, and at least one auxiliary pin upwardly protruding from the plate. A distance between a central point of the plate and the at least one auxiliary pin is different from a distance between the central point of the plate and the supporting pins.

According to an aspect of another exemplary embodiment, there is provided a supporting unit comprising a plate, a plurality of supporting pins upwardly protruding from the plate, and at least one auxiliary pin upwardly protruding from the plate. A distance between a central point of the plate and the at least one auxiliary pin is different from a distance between the central point of the plate and the supporting pins, and an external shape of the at least one auxiliary pin is different from that of the supporting pins after the at least one auxiliary pin and the supporting pins are installed on the plate.

### BRIEF DESCRIPTION OF THE DRAWINGS

The above and other aspects will become more apparent in view of the following detailed description with reference to the attached drawings, in which:

FIG. 1 is a cross sectional view schematically illustrating a substrate treatment apparatus according to an exemplary embodiment;

FIG. 2 is a plan view illustrating an example of a supporting unit in the substrate treatment apparatus of FIG. 1;

FIG. 3 is a front view illustrating the supporting unit of FIG. 2;

FIGS. 4 to 6 are plan views illustrating other examples of the supporting unit of FIG. 2, respectively;

FIGS. 7 to 14 are front views illustrating still other examples of the supporting unit of FIG. 2, respectively;

FIG. 15 is a plan view illustrating still another example of the supporting unit of FIG. 2;

FIG. 16 is a front view illustrating another example of the supporting unit in the substrate treatment apparatus of FIG. 1;

FIGS. 17 to 21 are front views illustrating other examples of the supporting unit of FIG. 16, respectively;

FIG. 22 is a front view illustrating still another example of the supporting unit in the substrate treatment apparatus of FIG. 1;

FIG. 23 is a plan view illustrating the supporting unit of FIG. 22;

FIGS. 24 and 25 are front views illustrating other examples of the supporting unit of FIG. 22, respectively;

FIG. 26 is a front view illustrating yet another example of the supporting unit in the substrate treatment apparatus of FIG. 1;

FIG. 27 is a plan view illustrating the supporting unit of FIG. 26;

FIGS. 28 to 32 are front views illustrating other examples of the supporting unit of FIG. 26, respectively;

FIGS. 33A to 33F are cross sectional views illustrating wafer states during a process performed using a supporting unit including a plate and supporting pins; and

FIGS. 34, 35 and 36 are cross sectional views illustrating wafer states during processes performed using supporting units of FIGS. 3, 16 and 30, respectively.

### DETAILED DESCRIPTION

The inventive concept will now be described more fully hereinafter with reference to the accompanying drawings, in which exemplary embodiments are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, exemplary embodiments are not limited to the specific examples provided herein and are exaggerated for clarity.

Although the exemplary embodiments are described in conjunction with an annealing apparatus for performing a flash annealing process as a substrate treatment apparatus, the inventive concept is not limited to an annealing apparatus. That is, the annealing apparatus according to the exemplary embodiments may be applicable to annealing processes other than the flash annealing process. Further, supporting units according to the exemplary embodiments may also be used in an apparatus that perform a process other than an annealing process.

In addition, although the exemplary embodiments are described in conjunction with a wafer used in fabrication of semiconductor chips as a substrate, the substrate is not limited to a wafer. For example, the substrate may include a panel such as a glass substrate used in fabrication of flat panel displays.

The terminology used herein is for the purpose of describing particular exemplary embodiments only and is not intended to limit the inventive concept. As used herein, the singular terms “a,” “an” and “the” are intended to include the plural forms as well, unless the context clearly indicates otherwise. As used herein, the term “and/or” includes any and all combinations of one or more of the associated listed items.

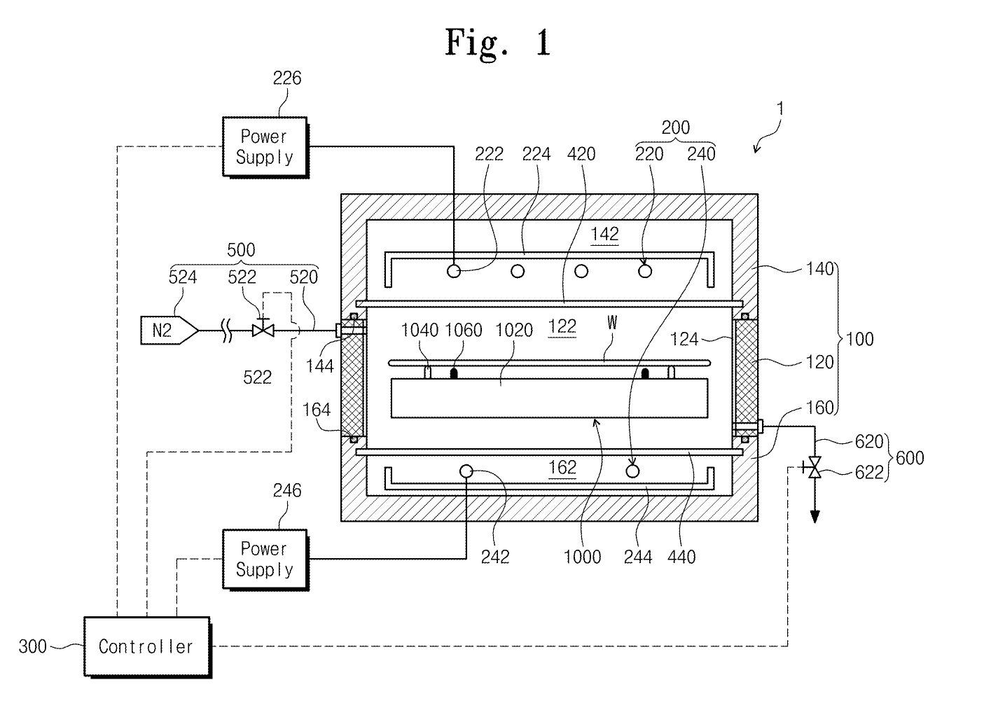

FIG. 1 is a cross sectional view schematically illustrating a substrate treatment apparatus according to an exemplary embodiment. The substrate treatment apparatus may be used to perform an annealing process that heats a wafer W to which an ion implantation process is applied in order to activate ion impurities in the wafer W. Referring to FIG. 1, the substrate treatment apparatus 1 may include a chamber 100, a heating member 200, a supporting unit 1000 and a controller 300. The chamber 100 may provide a space in which an annealing process is applied to a wafer W.

During the annealing process, the wafer W is located on the supporting unit 1000 and is heated by the heating member 200. An inside space of the chamber 100 may be filled with an inert gas by operation of a gas supply member 500 and an exhaust member 600. The controller 300 may control the heating member 200, the gas supply member 500 and the exhaust member 600 to perform an annealing process under conditions and a sequence of operations that may include a point of time to heat the wafer W, a heating temperature, a point of time to supply gases to the chamber, and a point of time to remove exhaust gases from the chamber. Components of the substrate treatment apparatus 1 will be described more fully hereinafter.

The chamber 100 may have a body 120, an upper chamber 140 and a lower chamber 160. The body 120 may have a shape of a pipe with upper and lower openings. The body 120 may have a circular shape or a rectangular shape in a plan view. The body 120 may also have a slit (not shown) penetrating a wall thereof, and the wafer W may be loaded into the chamber 100 or unloaded from the chamber 100 through the slit. The silt of the body 120 may be opened or closed by a door (not shown).

The upper chamber 140 may be disposed on the body 120 and combined with an upper end of the body 120. A sealing member 144 may be disposed between the body 120 and the upper chamber 140 to seal spaces between the body 120 and the upper chamber 140. The upper chamber 140 may have a shape of a tub with a lower opening. That is, an upper portion of the upper chamber 140 may be closed, and a lower portion of the upper chamber 140 may be open. An upper window 420 may be disposed between the inside space of the upper chamber 140 and the inside space of the body 120. A lamp 222 may be disposed inside the upper chamber 140 and a light from the lamp 222 may pass through the upper window 420. That is, the lamp 222 may be disposed in a space between the upper window 420 and the upper chamber 140. The upper window 420 may be formed of a quartz material. The upper window 420 may be combined with a lower end of the upper chamber 140. Alternatively, the upper window 420 may be combined with an intermediate portion or an upper portion of the upper chamber 140. That is, the upper window 420 may be disposed at a higher level than the lower end of the upper chamber 140.

The lower chamber 160 may be disposed under the body 120 and combined with a lower end of the body 120. A sealing member 164 may be disposed between the body 120 and the lower chamber 160 to seal spaces between the body 120 and the lower chamber 160. The lower chamber 160 may have a shape of a pipe with an upper opening. That is, a lower portion of the lower chamber 160 may be closed, and an upper portion of the lower chamber 160 may be open. A lower window 440 may be disposed between the inside space of the lower chamber 160 and the inside space of the body 120. A lamp 242 may be disposed inside the lower chamber 160 and a light from the lamp 242 may pass through the lower window 440. That is, the lamp 242 may be disposed in a space between the lower window 440 and the lower chamber 160. The lower window 440 may be formed of a quartz material. The lower window 440 may be combined with an upper end of the lower chamber 160. Alternatively, the lower window 440 may be combined with an intermediate portion or a lower portion of the lower chamber 160. That is, the upper window 440 may be disposed at a lower level than the upper end of the lower chamber 160.

A space surrounded by the body 120, the upper window 420 and the lower window 440 may correspond to a thermal treatment space 122 in which an annealing process is applied to the wafer W. That is, the thermal treatment space 122 may be defined by and bounded by the body 120, the upper window 420 and the lower window 440.

The heating member 200 may apply heat to the wafer W during the annealing process. The heating member 200 may have an upper heater 220 and a lower heater 240. The lower heater 240 may preliminarily apply heat to the wafer W to achieve a temperature which is lower than a process temperature during an initial step of the annealing process, and the upper heater 220 may apply heat to the wafer W to achieve the process temperature after the initial step of the annealing process. In an exemplary embodiment, both the lower heater 240 and the upper heater 220 may be used to heat the wafer W to the process temperature.

The upper heater 220 may include a light source 222, a reflector 224 and a power supply 226.

The light source 222 may be connected to the power supply 226. The light source 222 may be installed in an inner space 142 of the upper chamber 140. In more detail, the light source 222 may be disposed in a space surrounded by the upper chamber 140 and the upper window 420. The light source 222 may include one or more lamps. Each of the lamps 222 may have a bar shape, and the plurality of lamps 222 may be disposed to be parallel with each other. The lamps 222 may be disposed in a plane which is parallel with the wafer W that is put on the supporting unit 1000. Further, the lamps 222 may be disposed to be spaced apart from each other by a certain distance. A flash lamp may be used as the lamp 222. For example, each of the lamps 222 may include a xenon flash lamp. Each of the lamps 222 may generate a light periodically. That is, the light from the lamp 222 may be provided in a pulse signal form, and an interval between the pulses of the light may be equal to or less than several milliseconds. The flash lamp may irradiate the light onto the wafer W to rapidly increase a temperature of the wafer W containing implanted impurity ions. For example, the flash lamp 222 may heat the wafer W to a temperature of about 1200° C. rapidly. As such, the impurity ions in the wafer W may be fully activated without deep diffusion of the impurity ions.

The reflector 224 may be disposed over the light source 222 and in the inner space 142 of the upper chamber 140. The reflector 224 may reflect the light from the light source 222 into the thermal treatment space 122. The reflector 224 may have a sufficient size to cover all the lamps 222 when viewed from a top side toward a bottom side. Edges of the reflector 224 may downwardly extend to concentrate the light which is reflected from the reflector 224. However, the reflector 224 is not limited to any particular shape, as long as the reflector 224 concentrates the light which is reflected from the reflector 224.

The lower heater 240 may include a light source 242, a reflector 244 and a power supply 246. The light source 242 may be connected to the power supply 246. The light source 242 may be installed in an inner space 162 of the lower chamber 160. In more detail, the light source 242 may be disposed in a space surrounded by the lower chamber 160 and the lower window 440. The light source 242 may include one or more lamps. The lamp 242 may have the same kind lamp as the lamp 222 of the upper heater 220. Further, the lamp 242 may have the same shape as the lamp 222 of the upper heater 220. That is, the lamps 242 may have a bar shape, and the lamps 242 may be disposed to be parallel with each other. The lamps 242 may be disposed in a plane which is parallel with the wafer W put on the supporting unit 1000. Further, the lamps 242 may be disposed to be spaced apart from each other by a certain distance. The number of the lamps 242 of the lower heater 240 may be equal to the number of the lamps 222 of the upper heater 220. Alternatively, the number of the lamps 242 of the lower heater 240 may be different from the number of the lamps 222 of the upper heater 220. For example, the upper heater 220 may have four lamps 222, and the lower heater 240 may have two lamps 242.

The reflector 244 may be disposed below the light source 242 and in the inner space 162 of the lower chamber 160. The reflector 244 may reflect the light from the light source 242 into the thermal treatment space 122. The reflector 244 may have a sufficient size to cover all the lamps 242 when viewed from a bottom side toward a top side. Edges of the reflector 244 may upwardly extend to concentrate the light which is reflected from the reflector 244. However, as with the reflector 224, the reflector 244 is not limited to any particular shape, as long as the reflector 224 concentrates the light which is reflected from the reflector 244.

Unlike the exemplary embodiments described above, halogen lamps or arc lamps may be used as the light source of the lower heater 240. In this case, the lower heater 240 may irradiate lights toward the wafer W even after the initial step of the annealing process.

Returning to FIG. 1, a reflector 124 may be disposed on an inner sidewall of the body 120. The reflector 124 may reflect a portion of the light generated from the heating member into the thermal treatment space 122, thereby improving an efficiency of the annealing process. The reflector 124 may have a ring shape in a plan view. The reflector 124 may be provided to cover an entire portion of the inner sidewall of the body 120.

A gas supply conduit 520 may be connected to the sidewall of the body 120. The gas supply conduit 520 may also be connected to a gas supply source 524 in order to introduce a gas from the gas supply source 524 into the thermal treatment space 122. The gas supplied from gas supply source 524 may include an inert gas, for example, a nitrogen gas. A valve 522 may be installed at a portion of the gas supply conduit 520. The valve 522 may include a switch valve which is capable of closing or opening an inner path of the gas supply conduit 520. Alternatively, the valve 522 may include a mass flow controller (MFC) that controls an amount of the gas flowing through the gas supply conduit 520. Further, an exhaust conduit 620 may be connected to the sidewall of the body 120.

In an exemplary embodiment, the exhaust conduit 620 may be connected to a lower portion of the sidewall of the body 120. A valve 622 may be installed at a portion of the exhaust conduit 620. An inner path of the gas supply conduit 520 may be closed or opened by the valve 622. During the annealing process, an inert gas may be used as an ambient gas of the thermal treatment space 122. If the wafer W is introduced into the thermal treatment space 122, a nitrogen gas may be supplied into the thermal treatment space 122 through the gas supply conduit 520 and air existing in the thermal treatment space 122 may be vented through the exhaust conduit 620.

The controller 300 may control all the components of the substrate treatment apparatus 1. For example, the controller 300 may control a point of time to apply electricity from the power supplies 226 and 246 to the heating member 200 and may control an amount of the electricity generated from the power supplies 226 and 246. Further, the controller 300 may control the valve 522 installed at the gas supply conduit 520 and the valve 622 installed at the exhaust conduit 620, thereby adjusting a point of time to close or open the valves 522 and 622.

The supporting unit 1000 may be disposed in the thermal treatment space 122, thereby supporting the wafer W during the annealing process. The supporting unit 1000 may include a plate 1020, supporting pins 1040 and auxiliary pins 1060. The supporting pins 1040 and the auxiliary pins 1060 may be installed on the plate 1020. The supporting pins 1040 may directly support the wafer W during the annealing process. The auxiliary pins 1060 may prevent the wafer W from being in contact with or colliding with the plate 1020 due to thermal deformation (e.g., warpage) of the wafer W during the annealing process.

Hereinafter, diverse examples of the supporting unit 1000 will be described in detail. In the following descriptions to the examples of the supporting unit 1000, the term “an external shape of the pins (the supporting pins and/or the auxiliary pins)” may be construed as including a size of the pins and a shape of the pins. Further, the term “a size of the pins” may be construed as including a length of the pins and/or an area of the pins, and the term “a configuration of the pins” may be construed as including a shape of a cross sectional view of the pins and/or a shape of an upper end of the pins. Moreover, it will be understood that when external shapes of the pins installed on the plate are referred to as being “same as each other” or “different from each other”, heights of the upper ends of the pins installed on the plate can be same or different.

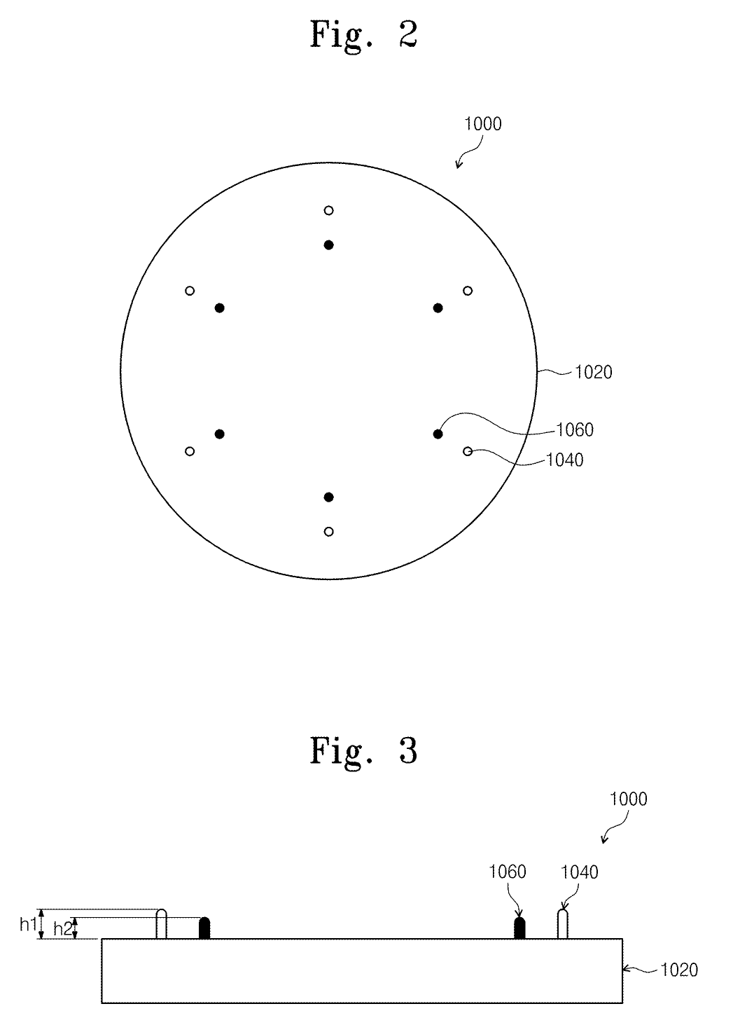

FIG. 2 is a plan view illustrating an example of a supporting unit in the substrate treatment apparatus of FIG. 1, and FIG. 3 is a front view illustrating the supporting unit of FIG. 2. Referring to FIGS. 2 and 3, a top surface of the plate 1020 may have a circular shape. When viewed from a top view, an area the top surface of the plate 1020 may be greater than that of a top surface of the wafer W. Holes (not shown) are disposed to vertically penetrate the plate 1020. Lift pins (not shown) are respectively disposed in the holes, and the lift pins are movable upwardly and downwardly. When the wafer W is loaded into the chamber 100, the lift pins may be moved up to protrude from the top surface of the plate 1020 and the wafer W may be put on the protruded lift pins. The protruded lift pins may then be moved down so that the wafer W is located on the supporting pins 1040. The plate 1020 may be formed of a transparent material through which a light can permeate. For example, the plate 1020 may be formed of a quartz material.

The supporting pins 1040 may be provided on the plate 1020 to protrude from the top surface of the plate 1020. The supporting pins 1040 may be fixed to the plate 1020. The number of the supporting pins 1040 may be two or more. In the exemplary embodiment of FIG. 2, six supporting pins 1040 are provided on the plate 1020. However, the number of the supporting pins 1040 is not limited to six. The number of the supporting pins 1040 may be less than six or more than six. For example, the number of the supporting pins 1040 may be at least three. The supporting pins 1040 may have substantially a same external shape. Further, after the supporting pins 1040 are installed on the plate 1020, the installed supporting pins 1040 may also have substantially a same external shape.

In an exemplary embodiment, each of the supporting pins 1040 may have a same horizontal cross sectional view at all positions thereof. That is, the horizontal cross sectional view of an upper end of the supporting pin 1040 may have substantially the same shape as the horizontal cross sectional views of a lower end and an intermediate portion of the supporting pin 1040. For example, the horizontal cross sectional views of the supporting pins 1040 may have a circular shape or a polygonal shape. Alternatively, a horizontal cross sectional area of each supporting pin 1040 may be gradually reduced as the horizontal cross sectional area becomes closer to the upper end or the lower end of each supporting pin 1040. For example, the supporting pins 1040 may have a circular cone shape or a pyramid shape. The upper ends of the supporting pins 1040 may have a top surface with a convex shape. In an exemplary embodiment, the supporting pins 1040 may have substantially a same length, and the length of the supporting pins 1040 may correspond to a distance h1 between the wafer W put on the supporting pins 1040 and the top surface of the plate 1020. In an exemplary embodiment, the distance h1 may be equal to or less than about 2 millimeters. For example, the distance h1 may be within the range of about 1 millimeter to about 2 millimeters. However, the distance h1 is not limited to the above descriptions. That is, the length of the supporting pins 1040 may be greater than 2 millimeters. The supporting pins 1040 may be located at positions which are spaced apart from a central point of the plate 1020 by a same distance. The supporting pins 1040 may be disposed to be spaced apart from each other. Further, the supporting pins 1040 may be arrayed in a circular ring. Angles between two adjacent lines of straight lines connecting the central point of the plate 1020 to the supporting pins 1040 may be substantially the same. The supporting pins 1040 may be formed of a material that does not absorb light and heat. That is, the supporting pins 1040 may be formed of a material that the light and/or the heat can permeate. Further, the supporting pins 1040 may be formed of a material which is thermally stable. In an exemplary embodiment, the supporting pins 1040 may include substantially the same material as the plate 1020. For example, the supporting pins 1040 may be formed of a quartz material.

When the annealing process is performed, the wafer W in the chamber 100 may be bent so that a central region of the wafer W is recessed to become closer to the plate 1020. However, the auxiliary pins 1060 may prevent the central region of the wafer W from being in contact with or colliding with the plate 1020. The auxiliary pins 1060 may be provided to protrude from the top surface of the plate 1020. The auxiliary pins 1060 may be fixed to the plate 1020. The number of the auxiliary pins 1060 may be two or more. The auxiliary pins 1060 may have substantially a same external shape. Further, after the supporting pins 1040 are installed on the plate 1020, the installed auxiliary pins 1060 may also have substantially a same external shape. The auxiliary pins 1060 may be located at positions which are spaced apart from a central point of the plate 1020 by a same distance. The auxiliary pins 1060 may be disposed to be spaced apart from each other. Further, the auxiliary pins 1060 may be arrayed in a circular ring. Angles between two adjacent lines of straight lines connecting the central point of the plate 1020 to the auxiliary pins 1060 may be substantially equal to each other.

The auxiliary pins 1060 may be disposed to be closer to the central point of the plate 1020, as compared with the supporting pins 1040. The number of the auxiliary pins 1060 may be equal to that of the supporting pins 1040. In this case, the auxiliary pins 1060 may be disposed in straight lines connecting the central point of the plate 1020 to the supporting pins 1040, respectively. The auxiliary pins 1060 may have substantially the same external shape as the supporting pins 1040 except for the length thereof. After the supporting pins 1040 and the auxiliary pins 1060 are installed on the plate 1020, the installed supporting pins 1040 may have a different external shape from the installed auxiliary pins 1060. In an exemplary embodiment, the length of the installed auxiliary pins 1060 may be less than the length of the installed supporting pins 1040. That is, a height h2 of the installed auxiliary pins 1060 may be less than the distance h1 (corresponding to a height of the installed supporting pins 1040). The auxiliary pins 1060 may be formed of a material that does not absorb light and heat. That is, the auxiliary pins 1060 may be formed of a material that the light and/or the heat cannot permeate. Further, the auxiliary pins 1060 may be formed of a material which is thermally stable. In an exemplary embodiment, the auxiliary pins 1060 may include substantially the same material as the supporting pins 1040. According to the above exemplary embodiments, the auxiliary pins 1060 may be arrayed in a circular ring. However, array of the auxiliary pins 1060 is not limited to the above descriptions. For example, at least one of the auxiliary pins 1060 may be disposed to be out of a circular ring. That is, the auxiliary pins 1060 may be irregularly arrayed.

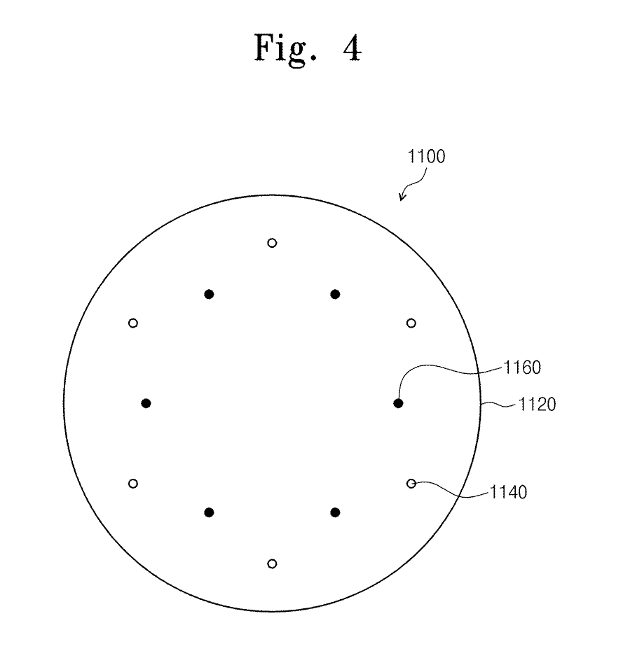

The number of the pins 1040 and 1060 and the disposition of the pins 1040 and 1060 may be diversely modified. FIGS. 4 to 6 are plan views illustrating other examples of the supporting unit of FIG. 2, respectively.

Referring to a supporting unit 1100 of FIG. 4, the number of supporting pins 1140 may be equal to the number of auxiliary pins 1160. The auxiliary pins 1160 may be disposed to be out of straight lines connecting a central point of a plate 1120 to the supporting pins 1140. In an exemplary embodiment, the auxiliary pins 1160 may be disposed in areas between the straight lines connecting the central point of the plate 1120 to the supporting pins 1140, respectively. Further, all of distances between the auxiliary pins 1160 and the straight lines connecting the central point of the plate 1120 to the supporting pins 1140 may be equal to each other.

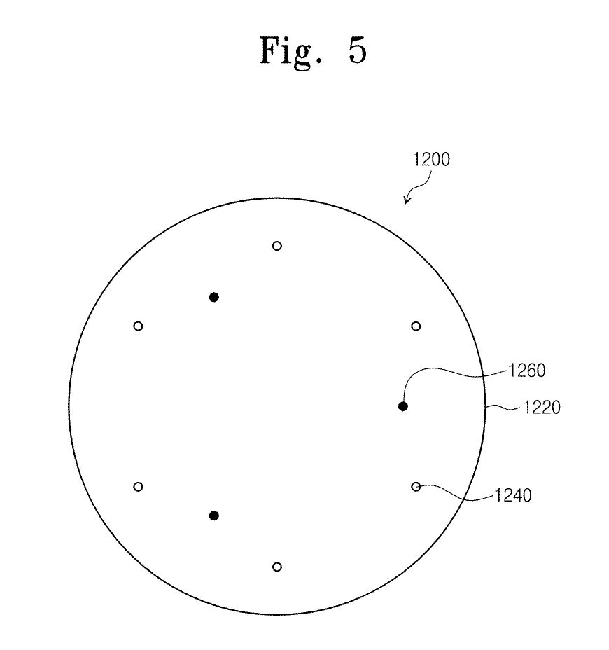

Referring to a supporting unit 1200 of FIG. 5, a plurality of supporting pins 1240 and a plurality of auxiliary pins 1260 may be provided, and the number of the supporting pins 1240 may be different from that of the auxiliary pins 1260. In an exemplary embodiment, the number of the supporting pins 1240 may be equal to “N” (wherein, “N” denotes a natural number which is equal to or greater than two) times that of the auxiliary pins 1260. Alternatively, the number of the supporting pins 1240 may be different from “N” times that of the auxiliary pins 1260. In another exemplary embodiment, the number of the auxiliary pins 1260 may be greater than that of the supporting pins 1240. The supporting pins 1240 may be located at positions which are spaced apart from a central point of a plate 1220 by a same distance. The auxiliary pins 1260 may be disposed to be out of straight lines connecting the central point of the plate 1220 to the supporting pins 1240. In an exemplary embodiment, distances between one of the auxiliary pins 1260 and a pair of the straight lines respectively located at both sides thereof may be equal to each other. Alternatively, the auxiliary pins 1260 may be disposed in every other line of the straight lines connecting the central point of the plate 1020 to the supporting pins 1040.

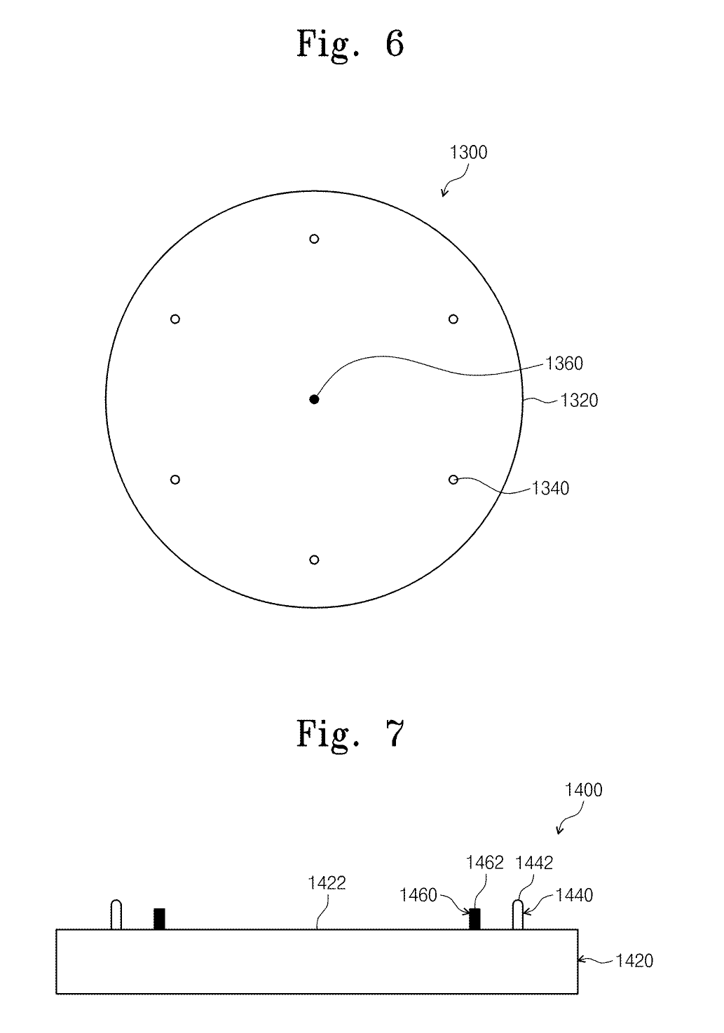

Referring to a supporting unit 1300 of FIG. 6, while a plurality of supporting pins 1340 are provided, only a single auxiliary pin 1360 may be provided. In this case, the single auxiliary pin 1360 may be disposed on a central point of a plate 1320.

A shape of the supporting pins may also be different from a shape of auxiliary pins. FIGS. 7 to 12 are front views illustrating diverse supporting units according to still other exemplary embodiments, respectively. In FIGS. 7 to 12, supporting pins 1440, 1540, 1640, 1740, 1840 and 1940 may have the same shape as the supporting pins 1040 of FIG. 3. Further, in FIGS. 7 to 12, top surfaces of the supporting pins 1440, 1540, 1640, 1740, 1840 and 1940 may be located at a higher level than top surfaces of auxiliary pins 1460, 1560, 1660, 1760, 1860 and 1960.

Referring to a supporting unit 1400 of FIG. 7, top surfaces 1442 of the supporting pins 1440 may have a different shape from top surfaces 1462 of the auxiliary pins 1460. That is, the top surfaces 1462 of the auxiliary pins 1460 may be substantially flat. After the auxiliary pins 1460 are installed on a plate 1420, the top surfaces 1462 of the installed auxiliary pins 1460 may be parallel with a top surface 1422 of the plate 1420. The auxiliary pins 1460 may have a same shape. In the event that the auxiliary pins 1460 are used, a contact area between the wafer W over the plate 1420 and the auxiliary pins 1460 may increase when the wafer W is deformed and/or warped.

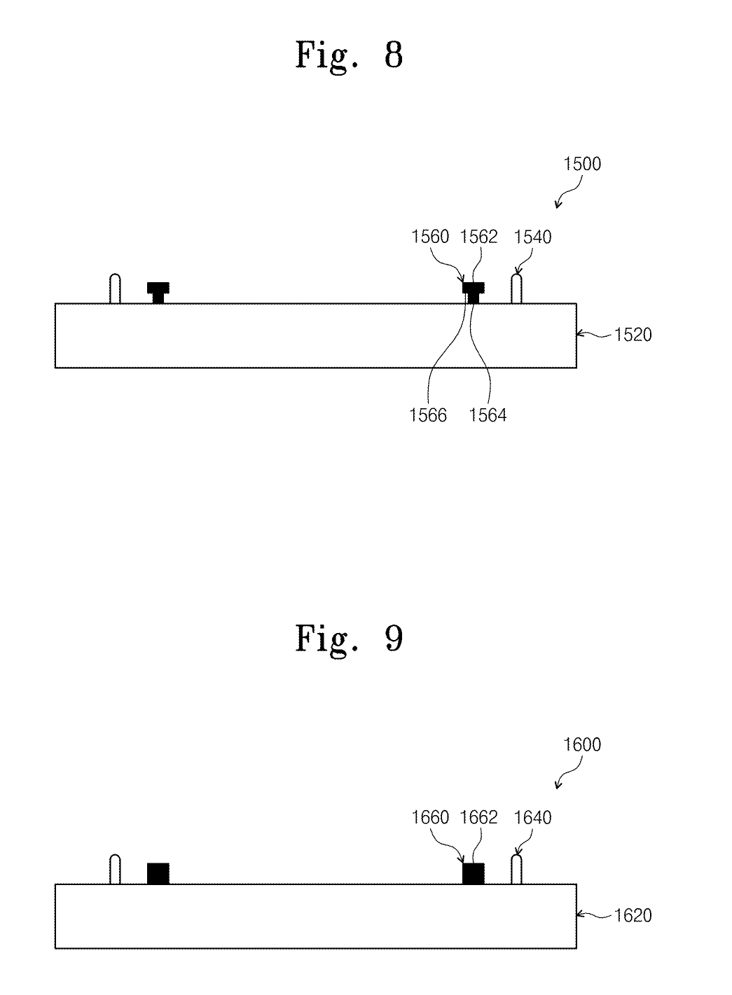

Referring to a supporting unit 1500 of FIG. 8, top surfaces 1562 of the auxiliary pins 1560 may be substantially flat. A horizontal cross sectional area of the respective auxiliary pins 1560 may be different according to a position where the horizontal cross sectional view is taken in each auxiliary pin 1560. In more detail, each of the auxiliary pins 1560 may have a lower portion 1564 fixed to the plate 1520 and an upper portion 1566 upwardly extending from the lower portion 1564. Each of the lower portions 1564 of the auxiliary pins 1560 may have the same horizontal cross sectional view and area at all positions in each lower portion 1564. Similarly, each of the upper portions 1566 of the auxiliary pins 1560 may have the same horizontal cross sectional view and area at all positions in each upper portion 1566. However, the horizontal cross sectional area of the upper portions 1566 may be greater than that of the lower portions 1564. For example, all of the horizontal cross sectional views of the upper portions 1566 and the lower portions 1564 may have a circular shape, and a diameter of the horizontal cross sectional views of the upper portions 1566 may be greater than that of the horizontal cross sectional views of the lower portions 1564. That is, the auxiliary pins 1560 may have a vertical cross-sectional shape of a “T”. In an exemplary embodiment, the lower portions 1564 of the auxiliary pins 1560 may be provided to have the same horizontal cross sectional view and area as the supporting pins 1540. In the event that the auxiliary pins 1560 are used, a contact area between the wafer W over the plate 1520 and the auxiliary pins 1560 may increase more when the wafer W is deformed and/or warped.

Referring to a supporting unit 1600 of FIG. 9, each of the auxiliary pins 1660 may have the same horizontal cross sectional view and area at all positions in each auxiliary pin 1660. Top surfaces 1662 of the auxiliary pins 1660 may be substantially flat. After the auxiliary pins 1660 are installed on a plate 1620, the top surfaces 1662 of the installed auxiliary pins 1660 may be parallel with the plate 1620. The horizontal cross sectional area of the auxiliary pins 1660 may be different from that of the supporting pins 1640. In an exemplary embodiment, the horizontal cross sectional area of the auxiliary pins 1660 may be greater than that of the supporting pins 1640. For example, all of the horizontal cross sectional views of the auxiliary pins 1660 and the supporting pins 1640 may have a circular shape, and a diameter of the horizontal cross sectional views of the auxiliary pins 1660 may be greater than that of the horizontal cross sectional views of the supporting pins 1640.

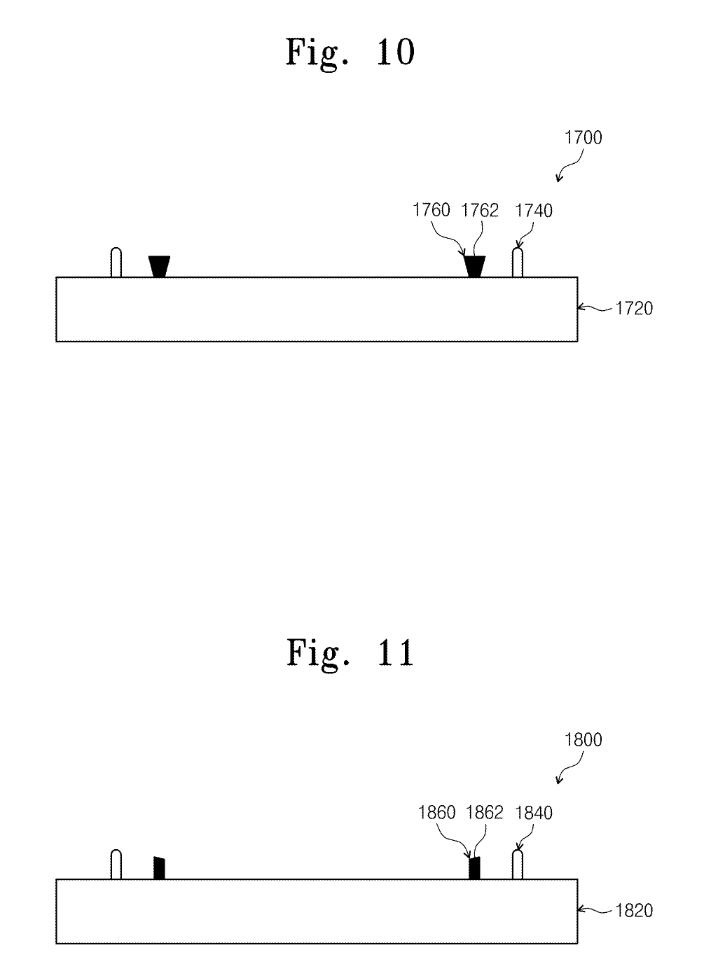

Referring to a supporting unit 1700 of FIG. 10, top surfaces 1762 of the auxiliary pins 1760 may be substantially flat. A horizontal cross sectional area of the respective auxiliary pins 1760 may be different according to a position where the horizontal cross sectional view is taken in each auxiliary pin 1760. In more detail, the horizontal cross sectional area of the respective auxiliary pins 1760 may be gradually increased as the horizontal cross sectional area becomes farther from a plate 1720. In an exemplary embodiment, the auxiliary pins 1760 may have a circular cone shape.

Referring to a supporting unit 1800 of FIG. 11, the auxiliary pins 1860 may be installed on a plate 1820 and may be perpendicular to the plate 1820. Top surfaces 1862 of the auxiliary pins 1860 may be substantially flat. After the auxiliary pins 1860 are installed on the plate 1820, the top surfaces 1862 of the installed auxiliary pins 1860 are not parallel with the plate 1820. In an exemplary embodiment, the top surfaces 1862 of the installed auxiliary pins 1860 may downwardly incline toward a central point of the plate 1820.

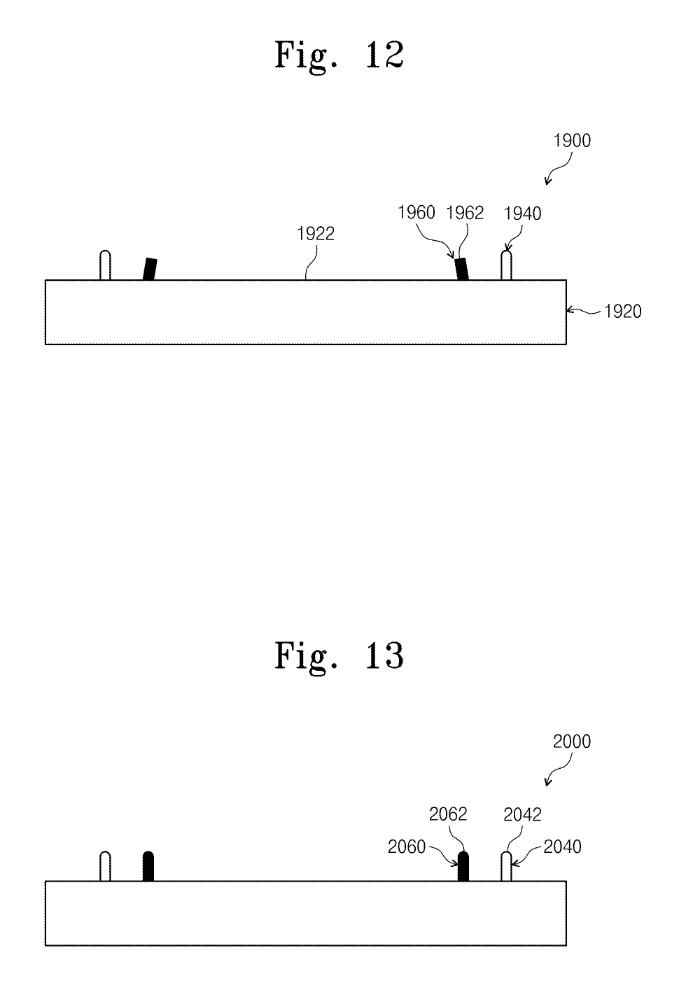

Referring to a supporting unit 1900 of FIG. 12, top surfaces 1962 of the auxiliary pins 1960 may be substantially flat, and each of the auxiliary pins 1960 may have a vertical central axis which is perpendicular to the top surface 1962 thereof. Further, the auxiliary pins 1960 may be installed on a plate 1920 to lean toward a central point of the plate 1920. Thus, the top surfaces 1962 of the installed auxiliary pins 1960 may downwardly incline toward the central point of the plate 1920.

According to the exemplary embodiments described with reference to FIGS. 7 to 12, the top surfaces of the auxiliary pins 1460, 1560, 1660, 1760, 1860 and 1960 may be substantially flat. However, the top surfaces of the auxiliary pins 1460, 1560, 1660, 1760, 1860 and 1960 may have a rounded convex shape that downwardly inclines toward the central points of the plates 1420, 1520, 1620, 1720, 1820 and 1920, respectively. Alternatively, the top surfaces of the auxiliary pins 1460, 1560, 1660, 1760, 1860 and 1960 may have diverse shapes which are different from the above descriptions.

In other exemplary embodiments, the supporting pins and the auxiliary pins illustrated in FIGS. 7 to 12 may be configured to have substantially the same number and/or disposition as the supporting pins and the auxiliary pins illustrated in FIGS. 2, 4 and 5. In still other exemplary embodiments, the supporting pins and the auxiliary pins illustrated in FIGS. 7 to 12 may be configured to have substantially the same number and/or disposition as the supporting pins and the auxiliary pins illustrated in FIG. 6.

According to the above exemplary embodiments, the top surfaces of the auxiliary pins may be lower than the top surfaces of the supporting pins. However, the inventive concept is not limited to the above exemplary embodiments. For example, top surfaces 2062 of auxiliary pins 2060 may be coplanar with top surfaces 2042 of the supporting pins 2040, as illustrated in a supporting unit 2000 of FIG. 13.

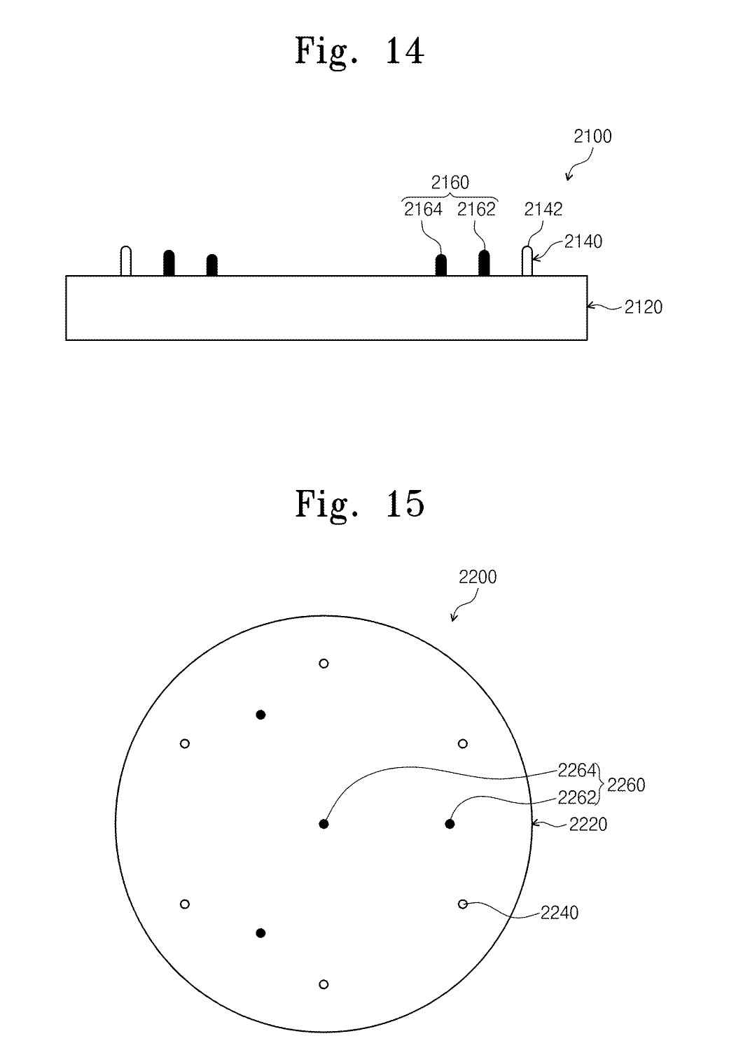

FIG. 14 is a front view illustrating a supporting unit 2100 according to still another exemplary embodiment. Referring to FIG. 14, auxiliary pins 2160 may include at least one first pin 2162 and at least one second pin 2164. In an exemplary embodiment, the auxiliary pins 2160 may include a plurality of first pins 2162 and a plurality of second pins 2164. The first pins 2162 may be disposed to be closer to a central point of a plate 2120 than the supporting pins 2140 are spaced apart from the central point of the plate 2120. The second pins 2164 may be disposed to be closer to the central point of the plate 2120 than the first pins 2162 are spaced apart from the central point of the plate 2120. The number of the first pins 2162 may be greater than that of the second pins 2164. Alternatively, the number of the first pins 2162 may be equal to that of the second pins 2164. Top surfaces of the first pins 2162 may be lower than top surfaces 2142 of the supporting pins 2140, and top surfaces of the second pins 2164 may be lower than the top surfaces of the first pins 2162. Alternatively, the top surfaces of the first and second pins 2162 and 2164 may be lower than the top surfaces 2142 of the supporting pins 2140, and the top surfaces of the first pins 2162 may be located at the same level as the top surfaces of second pins 2164. In another exemplary embodiment, a supporting unit 2200 may include a plurality of first pins 2262 and a single second pin 2264, as illustrated in FIG. 15. The first pins 2262 and the second pin 2264 may constitute auxiliary pins 2260, and the auxiliary pins 2260 and supporting pins 2240 may be installed on a plate 2220.

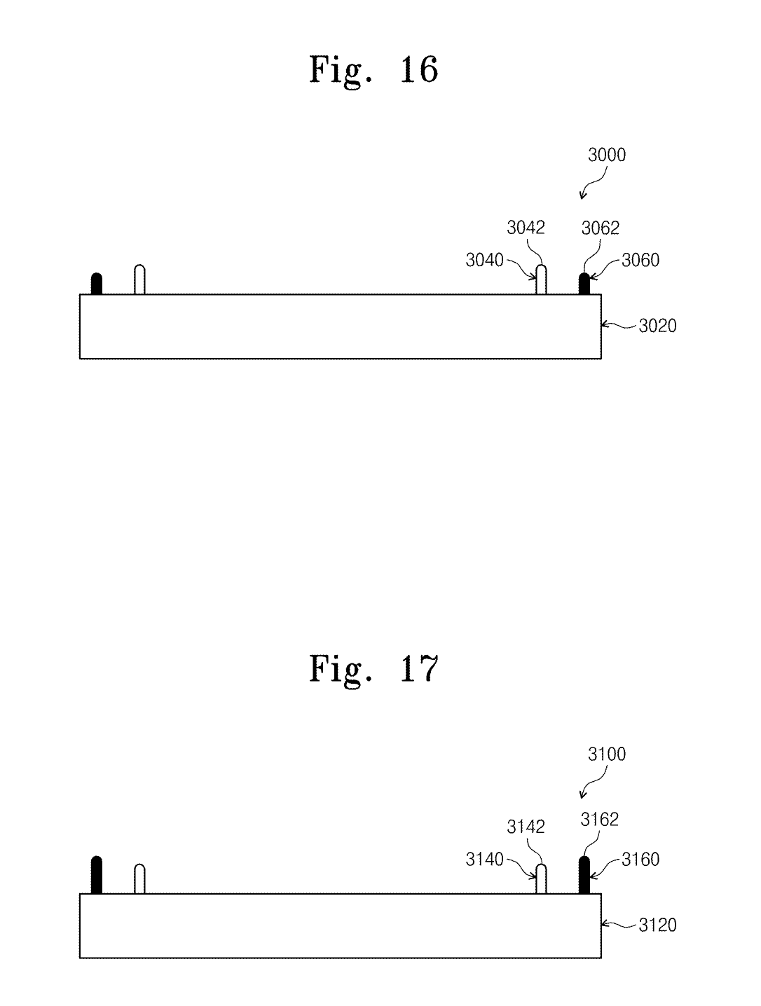

FIG. 16 is a front view illustrating a supporting unit 3000 according to yet still another exemplary embodiment. Referring to FIG. 16, the supporting unit 3000 may include a plate 3020, supporting pins 3040 and auxiliary pins 3060. The plate 3020 and the supporting pins 3040 may be configured to have substantially the same shapes as the plate 1020 and the supporting pins 1040 illustrated in FIG. 3, respectively. The auxiliary pins 3060 may prevent or minimize an edge of the wafer (‘W’ of FIG. 1) put on the supporting pins 1040 from being in contact with or colliding with the plate 3020 due to deformation (e.g., warpage) of the wafer W during an annealing process. The auxiliary pins 3060 may be configured to have substantially the same shapes and material as the auxiliary pins 1060 illustrated in FIG. 3. The auxiliary pins 3060 may be located to be farther from a central point of the plate 3020 than a distance between the supporting pins 3040 and the central point of the plate 3020. Top surfaces 3062 of the auxiliary pins 3060 may be lower than top surfaces 3042 of the supporting pins 3040. The number of the supporting pins 3040 may be two or more. The number of the auxiliary pins 3060 may be equal to that of the supporting pins 3040. Alternatively, the number of the auxiliary pins 3060 may be different from that of the supporting pins 3040. For example, the number of the auxiliary pins 3060 may be greater than that of the supporting pins 3040.

The supporting pins 3040 and the auxiliary pins 3060 may be configured to have diverse shapes. The supporting pins 3040 may be disposed in straight lines connecting the central point of the plate 3020 to the auxiliary pins 3060, respectively. Alternatively, the supporting pins 3040 may be disposed to be out of the straight lines connecting the central point of the plate 3020 to the auxiliary pins 3060.

The supporting pins 3040 and the auxiliary pins 3060 may be modified in diverse forms. For example, the supporting pins 3040 and the auxiliary pins 3060 may have substantially the same shapes as the supporting pins 1440, 1540, 1640, 1740, 1840 or 1940 and the auxiliary pins 1460, 1560, 1660, 1760, 1860 or 1960 illustrated in FIGS. 7 to 12, respectively. Alternatively, in the event that the top surfaces 3062 of the auxiliary pins 3060 have a sloped shape, the top surfaces 3062 of the auxiliary pins 3060 may downwardly incline toward an edge of the plate 3020. In another exemplary embodiment, the top surfaces 3062 of the auxiliary pins 3060 may be located at the same level as the top surfaces 3042 of the supporting pins 3040.

In another exemplary embodiment, a supporting unit 3100 may include auxiliary pins 3160 and supporting pins 3140, and top surfaces 3162 of the auxiliary pins 3160 may be located a higher level than top surfaces 3142 of the supporting pins 3140, as illustrated in FIG. 17. A difference of height between the auxiliary pins 3160 and the supporting pins 3140 may be small so that a wafer loaded on a plate 3120 is in contact with the supporting pins 3140 as well as the auxiliary pins 3160. In this case, the wafer loaded over the plate 3120 may be supported by the supporting pins 3140 and may be bent so that a central region of the wafer is closer to the plate 3120 than a distance between an edge of the wafer and the plate 3120. Thus, in the event that the auxiliary pins 3160 and the supporting pins 3140 of FIG. 17 are used, the distance between the edge of the wafer and the plate 3120 may be more increased when the wafer is bent.

According to some of the above exemplary embodiments, the auxiliary pins have a same height and the supporting pins also have a same height. However, the inventive concept is not limited to these exemplary embodiments. For example, at least one of the auxiliary pins may have a different height from the other auxiliary pins. Similarly, at least one of the supporting pins may have a different height from the other supporting pins.

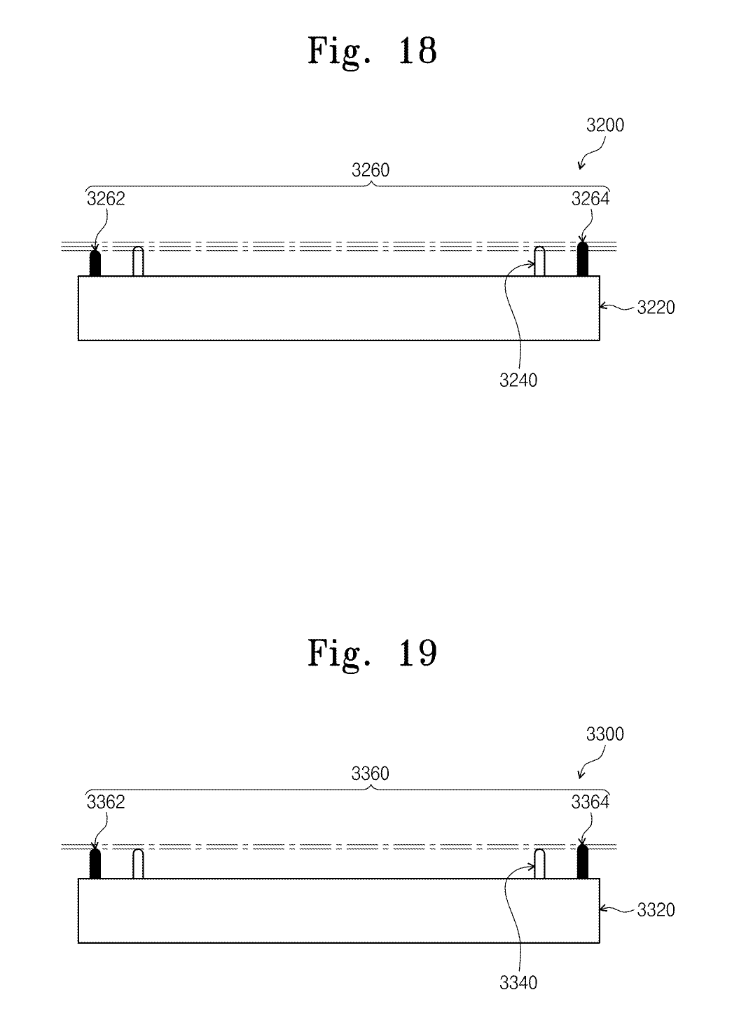

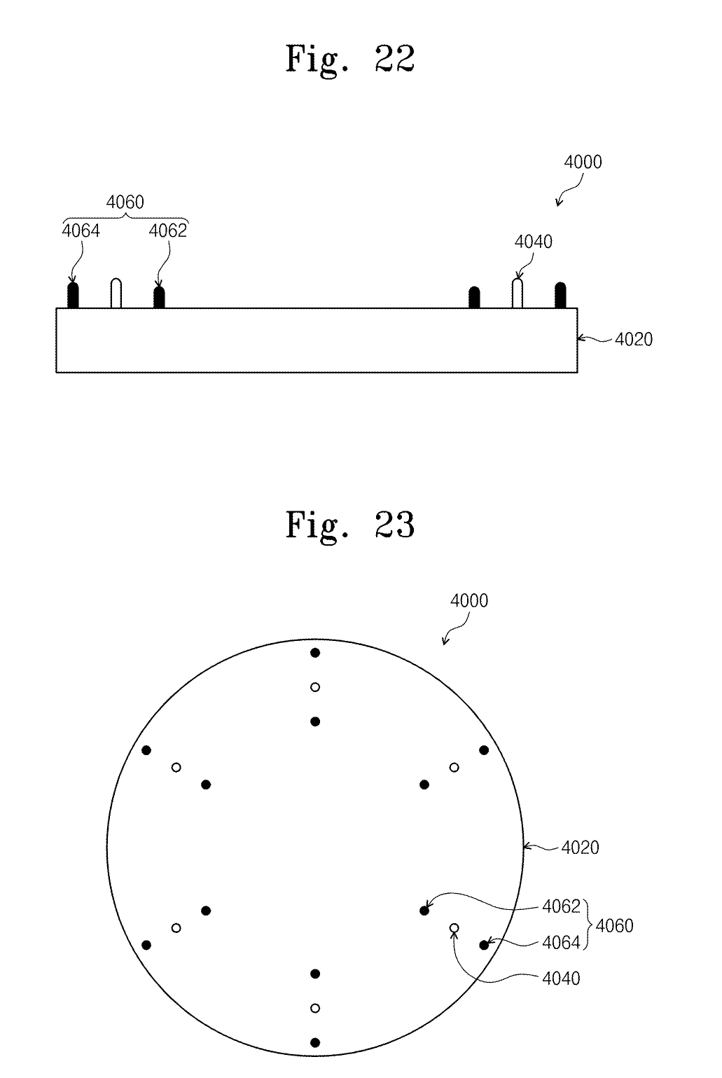

FIGS. 18 to 20 illustrate exemplary embodiments including auxiliary pins having different heights from each other, and FIG. 21 illustrates an exemplary embodiment including supporting pins having different heights from each other.

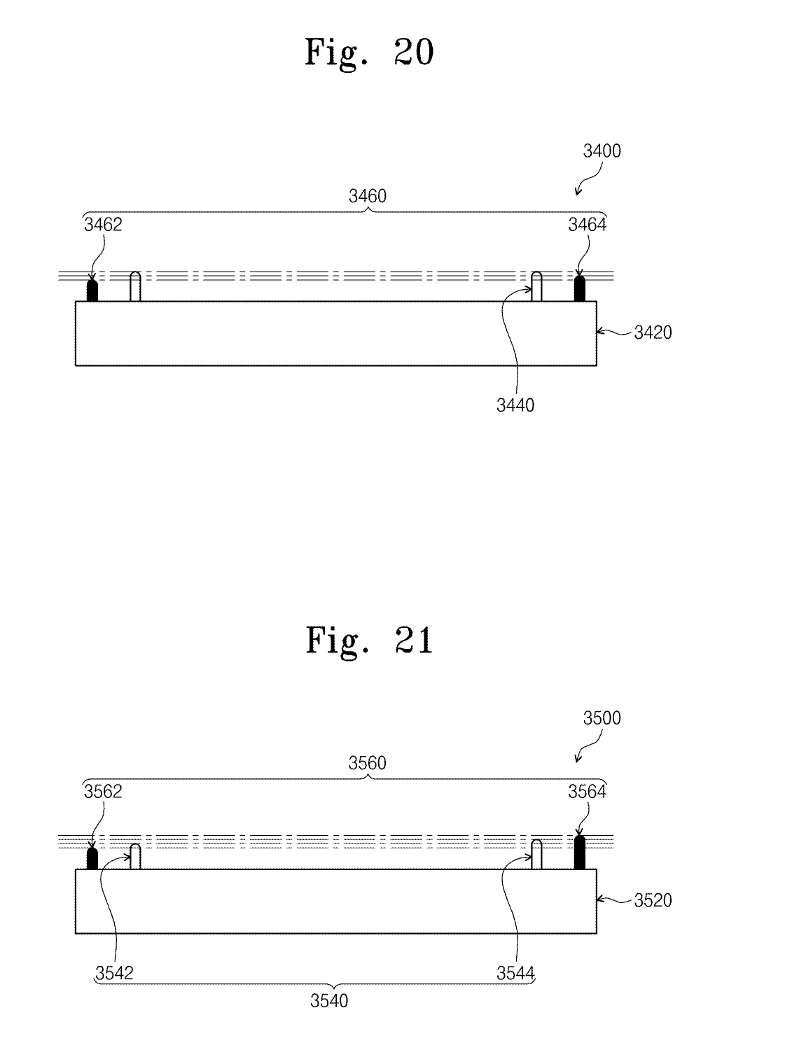

Referring to FIGS. 18 to 20, supporting pins 3240 may be located at positions which are spaced apart from a central point of a plate 3220 by a same distance (FIG. 18), supporting pins 3340 may be located at positions which are spaced apart from a central point of a plate 3320 by a same distance (FIG. 19), and supporting pins 3440 may be located at positions which are spaced apart from a central point of a plate 3420 by a same distance (FIG. 20). Similarly, auxiliary pins 3260 may be located at positions which are spaced apart from the central point of the plate 3220 by a same distance (FIG. 18), auxiliary pins 3360 may be located at positions which are spaced apart from the central point of the plate 3320 by a same distance (FIG. 19), and auxiliary pins 3460 may be located at positions which are spaced apart from the central point of the plate 3420 by a same distance (FIG. 20).

The auxiliary pins 3260 may be located to be farther from the central point of the plate 3220 than a distance between the supporting pins 3240 and the central point of the plate 3220 (FIG. 18), the auxiliary pins 3360 may be located to be farther from the central point of the plate 3320 than a distance between the supporting pins 3340 and the central point of the plate 3320 (FIG. 19), and the auxiliary pins 3460 may be located to be farther from the central point of the plate 3420 than a distance between the supporting pins 3440 and the central point of the plate 3420 (FIG. 20).

The supporting pins 3240 may have a same length, and the supporting pins 3340 may have a same length. Further, the supporting pins 3440 may also have a same length. In contrast, at least one of the auxiliary pins 3260 may have a different length from the other auxiliary pins 3260, at least one of the auxiliary pins 3360 may have a different length from the other auxiliary pins 3360, and at least one of the auxiliary pins 3460 may have a different length from the other auxiliary pins 3460. For example, as can be seen from a supporting unit 3200 illustrated in FIG. 18, first auxiliary pins 3262 of the auxiliary pins 3260 may have heights (e.g., lengths) which are less than heights of the supporting pins 3240, and second auxiliary pins 3264 of the auxiliary pins 3260 may have heights (e.g., lengths) which are greater than the heights of the supporting pins 3240.

In another exemplary embodiment, as can be seen from a supporting unit 3300 illustrated in FIG. 19, first auxiliary pins 3362 of the auxiliary pins 3360 may have the same heights (e.g., lengths) as the supporting pins 3340, and second auxiliary pins 3364 of the auxiliary pins 3360 may have heights (e.g., lengths) which are different from the heights of the supporting pins 3340. For example, the second auxiliary pins 3364 may have heights which are greater than the heights of the supporting pins 3340. Alternatively, the second auxiliary pins 3364 may have heights which are less than the heights of the supporting pins 3340.

In still another exemplary embodiment, as can be seen from a supporting unit 3400 illustrated in FIG. 20, all the auxiliary pins 3460 including first and second auxiliary pins 3462 and 3464 may have heights which are less than the heights of the supporting pins 3440.

Referring to a supporting unit 3500 of FIG. 21, supporting pins 3540 may be disposed at positions which are spaced apart from a central point of a plate 3520 by a same distance. Similarly, auxiliary pins 3560 may be located at positions which are spaced apart from the central point of the plate 3520 by a same distance. The auxiliary pins 3560 may be located to be farther from the central point of the plate 3520 than a distance between the supporting pins 3540 and the central point of the plate 3520. At least one of the supporting pins 3540 may have a different length from the other supporting pins 3540, and at least one of the auxiliary pins 3560 may also have a different length from the other auxiliary pins 3560. For example, first supporting pins 3542 of the supporting pins 3540 may have lengths which are less than lengths of second supporting pins 3544 of the supporting pins 3540. Moreover, first auxiliary pins 3562 of the auxiliary pins 3560 may have lengths which are less than lengths of the first supporting pins 3542, and second auxiliary pins 3564 of the auxiliary pins 3560 may have lengths which are greater than lengths of the second supporting pins 3544.

According to the exemplary embodiments illustrated in FIGS. 18 to 21, the auxiliary pins are disposed to be farther from the central points of the plates than the distances between the supporting pins and the central points of the plates. However, in other exemplary embodiments, the auxiliary pins 3260, 3360, 3460 and 3560 illustrated in FIGS. 18 to 21 may be disposed to be closer to the central points of the plates 3220, 3320, 3420 and 3520 than the distances between the supporting pins 3240, 3340, 3440 and 3540 and the central points of the plates.

As illustrated in FIGS. 18 to 21, the apparatus may include the auxiliary pins having different heights from each other or the supporting pins having different heights from each other. Accordingly, the apparatus may prevent an edge of a wafer put on a plate from colliding with the plate. That is, the apparatus may prevent the wafer from being broken or damaged.

FIGS. 22 and 23 illustrate a supporting unit according to yet still another exemplary embodiment. FIG. 22 is a front view of a supporting unit 4000, and FIG. 23 is a plan view of the supporting unit 4000. Referring to FIGS. 22 and 23, the supporting unit 4000 may include a plate 4020, supporting pins 4040 and auxiliary pins 4060. The plate 4020 and the supporting pins 4040 may have similar configurations to the plate 1020 and the supporting pins 1040 illustrated in FIG. 3, respectively. The auxiliary pins 4060 may prevent a wafer put on the plate 4020 from being colliding with the plate 4020 even though the wafer is deformed and/or warped during an annealing process. The auxiliary pins 4060 may include at least one inner pin 4062 and at least one outer pin 4064 with respect to the supporting pins 4040. The at least one inner pin 4062 may prevent a central portion of the wafer from being in contact with or colliding with the plate 4020 during the annealing process, and the at least one outer pin 4064 may prevent an edge of the wafer from being in contact with or colliding with the plate 4020 during the annealing process. Hereinafter, the exemplary embodiment will be described in conjunction with the supporting unit 4000 including a plurality of inner pins 4062 and a plurality of outer pins 4064.

The inner pins 4062 may be disposed to be closer to a central point of the plate 4020 than a distance between the supporting pins 4040 and the central points of the plates 4020, and the outer pins 4064 may be disposed to be farther from the central point of the plate 4020 than the distance between the supporting pins 4040 and the central points of the plates 4020. The inner pins 4062 and the outer pins 4064 may be modified to have diverse shapes. The inner pins 4062 and the outer pins 4064 may have the same shape as the supporting pins 4040. Alternatively, the inner pins 4062 and the outer pins 4064 may have substantially the same shape as any one group of the auxiliary pins 1460, 1560, 1660, 1760, 1860 and 1960 illustrated in FIGS. 7 to 12.

The inner pins 4062 and the outer pins 4064 may have a same height, and the height of the inner pins 4062 may be less than that of the supporting pins 4040. Alternatively, the height of the inner pins 4062 may be different from that of the outer pins 4064. For example, the outer pins 4064 may be taller than the inner pins 4062. In another exemplary embodiment, the inner pins 4062, the supporting pins 4040 and the outer pins 4064 may have a same height.

The inner pins 4062, the supporting pins 4040 and the outer pins 4064 may be arrayed diversely. For example, the inner pins 4062, the supporting pins 4040 and the outer pins 4064 may be disposed in straight lines that connect the central point of the plate 4020 to several edge points of the plate 4020, as illustrated in FIG. 23.

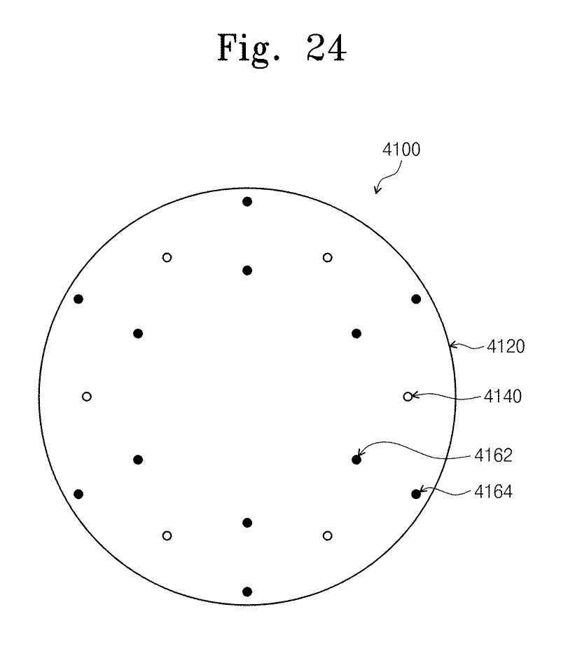

In another exemplary embodiment, as can be seen from a supporting unit 4100 illustrated in FIG. 24, inner pins 4162 and outer pins 4164 may be disposed in straight lines that connect a central point of a plate 4120 to several edge points of the plate 4120, and supporting pins 4140 may be disposed to be out of the straight lines in which the inner pins 4162 and outer pins 4164 are arrayed.

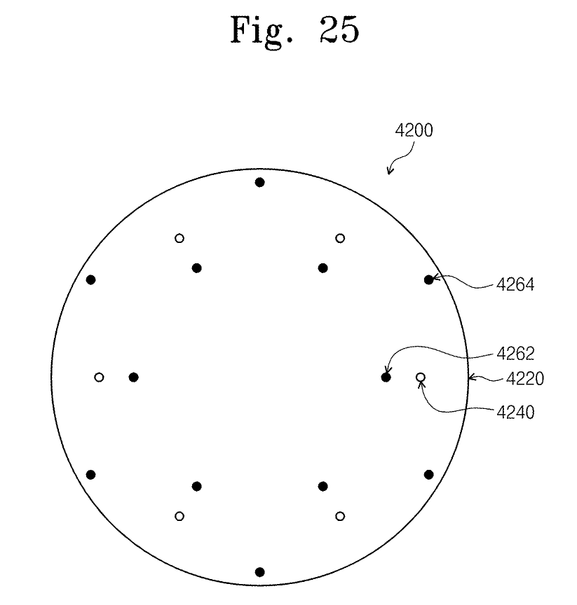

In still another exemplary embodiment, as can be seen from a supporting unit 4200 illustrated in FIG. 25, supporting pins 4240 as well as any one group of inner pins 4262 and outer pins 4264 may be disposed in straight lines that connect a central point of a plate 4220 to several edge points of the plate 4220, and the other group of the inner pins 4262 and the outer pins 4264 may be disposed to be out of the straight lines in which the supporting pins 4240 are disposed. Alternatively, only one group of the inner pins 4262, the supporting pins 4240 and the outer pins 4264 may be disposed in the straight lines that connect the central point of the plate 4220 to several edge points of the plate 4220.

The number of the inner pins 4062, the number of the supporting pins 4040 and the number of the outer pins 4064 may be equal to each other. In another exemplary embodiment, the number of the inner pins 4062 and the number of the outer pins 4064 may be equal to each other, and the number of the supporting pins 4040 may be different from the number of the inner pins 4062. In still another exemplary embodiment, the number of the inner pins 4062 may be less than the number of the outer pins 4064. For example, the supporting unit 4000 may include a single inner pin 4062 which is disposed on the central point of the plate 4020.

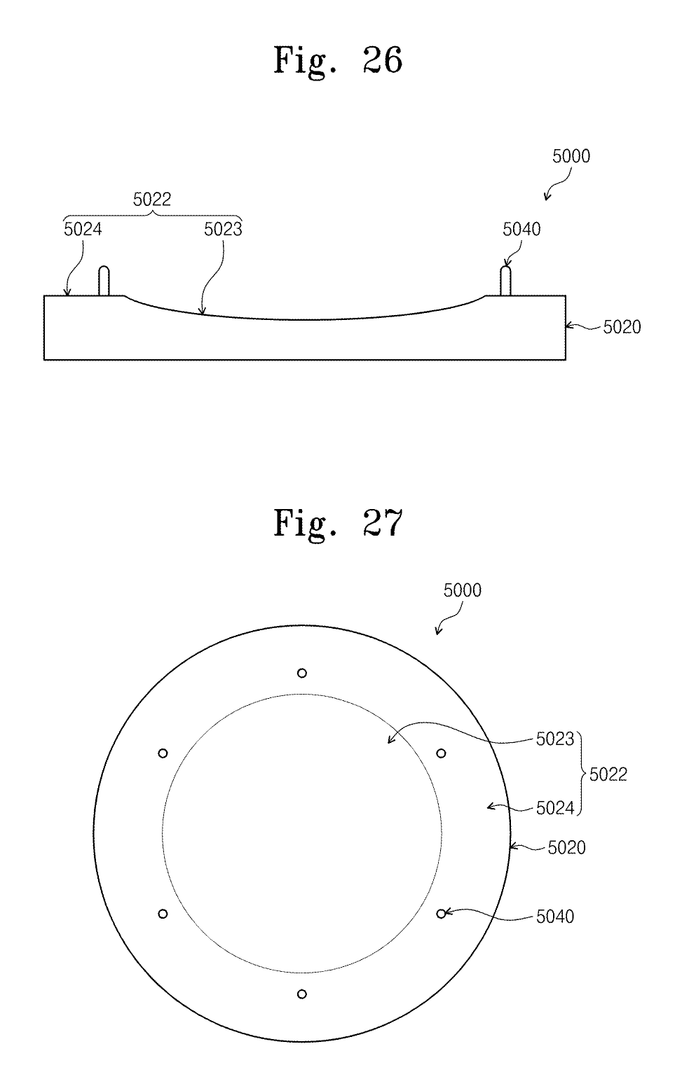

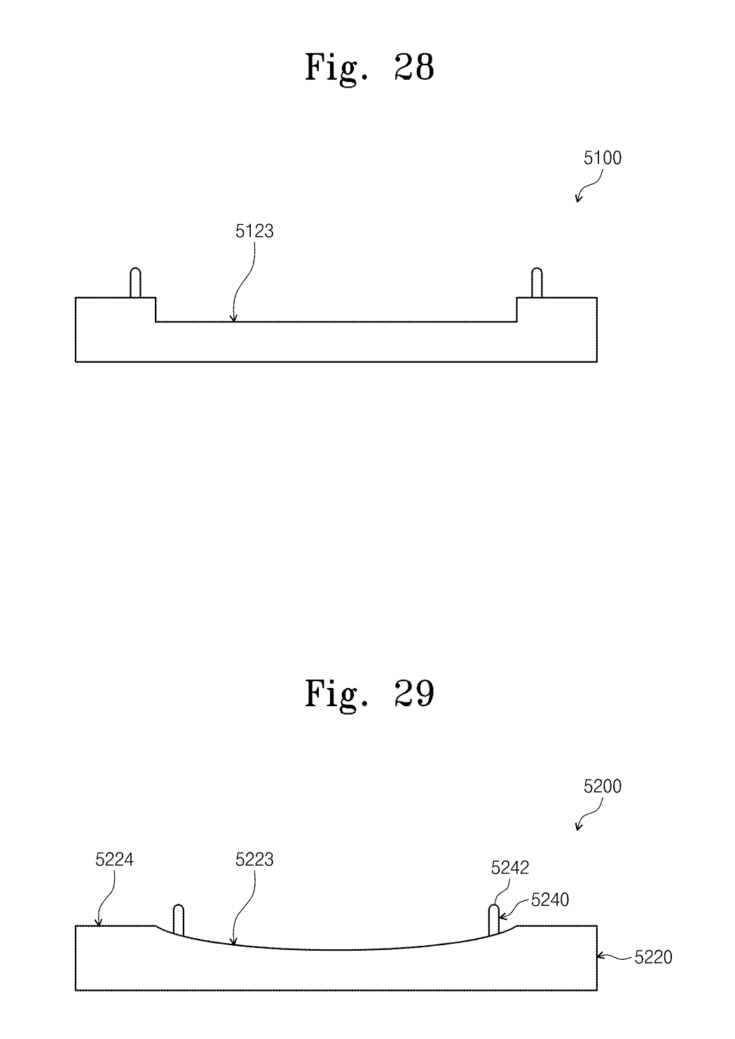

FIGS. 26 and 27 illustrate a supporting unit according to a further exemplary embodiment. FIG. 26 is a front view illustrating a supporting unit 5000, and FIG. 27 is a plan view illustrating the supporting unit 5000 of FIG. 26. Referring to FIGS. 26 and 27, the supporting unit 5000 may include a plate 5020 and supporting pins 5040. A top surface 5022 of the plate 5020 may include a concave portion 5023 and a flat portion 5024. The concave portion 5023 may be located in a central region of the plate 5020, and the flat portion 5024 may be located in an edge of the plate 5020. A surface of the concave portion 5023 may have a rounded shape, as illustrated in FIG. 26. For example, the surface of the concave portion 5023 may have a shape of an arc that corresponds to a portion of the circumference of a circle, when viewed from a vertical cross sectional view of the plate 5020. In another exemplary embodiment, as can be seen from a supporting unit 5100 illustrated in FIG. 28, a concave portion 5123 may have a flat bottom surface.

Referring again to FIGS. 26 and 27, the flat portion 5024 may extend from the concave portion 5123. The concave portion 5123 may prevent a central portion of a wafer put on the plate 5020 from being in contact with the plate 5020 even though the wafer is deformed or warped so that the central region of the wafer becomes closer to the plate 5020. The supporting pins 5040 may have a similar shape to the supporting pins 1040 illustrated in FIG. 3. The number of the supporting pins 5040 may be two or more, and the supporting pins 5040 may be installed on the flat portion 5024 of the plate 5020. Alternatively, as can be seen from a supporting unit 5200 illustrated in FIG. 29, supporting pins 5240 may be installed on a concave portion 5223 of a plate 5220. In this case, the supporting pins 5240 may be located to be adjacent to a flat portion 5224, and top surfaces 5242 of the supporting pins 5240 may be located at a higher level than the flat portion 5224.

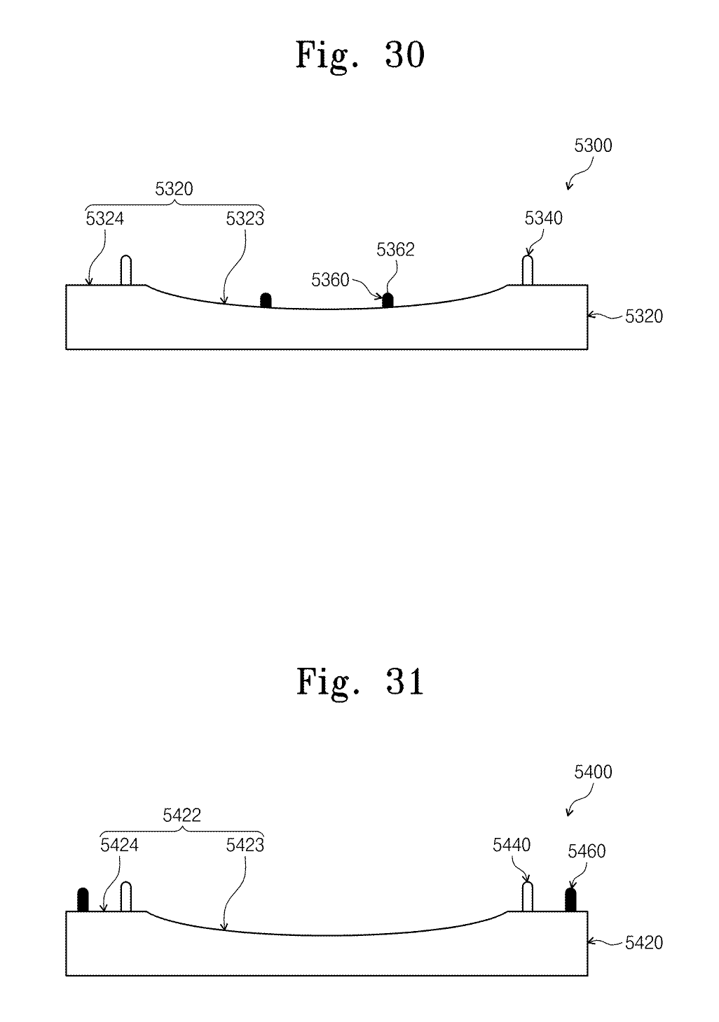

FIG. 30 is a front view illustrating a supporting unit according to another exemplary embodiment. As illustrated in FIG. 30, a supporting unit 5300 may include a plate 5320, supporting pins 5340 and auxiliary pins 5360. The plate 5320 and the supporting pins 5340 may have similar shapes to the plate 5020 and the supporting pins 5040 illustrated in FIG. 26, respectively. The auxiliary pins 5360 may be provided on a concave portion 5323. The number of the auxiliary pins 5360 may be two or more. Top surfaces 5362 of the auxiliary pins 5360 may be located at a lower level than a flat portion 5324 of the plate 5320. The auxiliary pins 5360 may prevent a central portion of a wafer put on the plate 5320 from being in contact with the concave portion 5323 of the plate 5320 even though the wafer is deformed or warped so that the central region of the wafer becomes closer to the plate 5320. The supporting unit 5300 may include a single auxiliary pin 5360 which is disposed on a central point of the plate 5320.

FIG. 31 is a front view illustrating a supporting unit according to still another exemplary embodiment. As illustrated in FIG. 31, a supporting unit 5400 may include a plate 5420, supporting pins 5440 and auxiliary pins 5460. The plate 5420 and the supporting pins 5440 may have similar shapes to the plate 5020 and the supporting pins 5040 illustrated in FIG. 26, respectively. The auxiliary pins 5460 may be provided on a flat portion 5424. The auxiliary pins 5460 may be disposed to be farther from a central point of the plate 5420 than a distance between the supporting pins 5440 and the central point of the plate 5420. The auxiliary pins 5460 may prevent an edge of a wafer put on the plate 5420 from being in contact with the flat portion 5424 of the plate 5420 even though the wafer is deformed or warped so that the edge of the wafer becomes closer to the flat portion 5424.

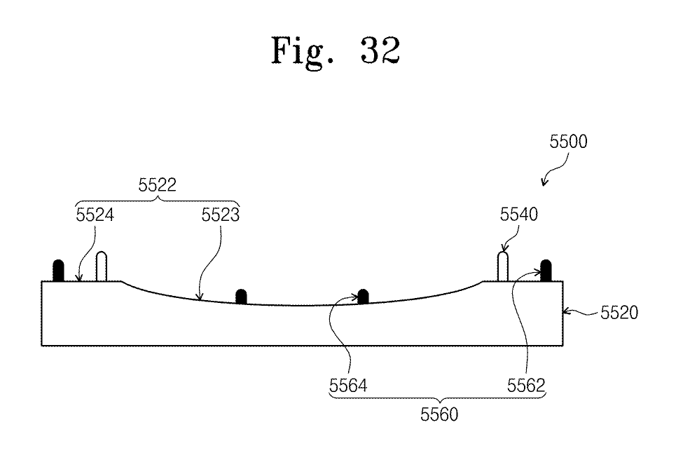

FIG. 32 is a front view illustrating a supporting unit according to yet still another exemplary embodiment. A supporting unit 5500 may include a plate 5520, supporting pins 5540 and auxiliary pins 5560. The auxiliary pins 5560 may include inner pins 5562 and outer pins 5564. The plate 5520, the supporting pins 5540 and the inner pins 5562 may have similar shapes to the plate 5320, the supporting pins 5340 and the auxiliary pins 5360 illustrated in FIG. 30, respectively. Further, the outer pins 5564 may have a similar shape to the auxiliary pins 5460 illustrated in FIG. 31.

Now, an example of processes performed using the substrate treatment apparatus of FIG. 1 will be described. First, a wafer W may be introduced into a thermal treatment space 122 by a transfer robot, and the wafer W may be put on supporting pins 1040. The wafer W may be then heated to a first temperature using lamps 242 during an initial step of an annealing process. The lamps 242 may heat the wafer W using a continuous heating method. After heating the wafer W to the first temperature, the wafer W may be heated to a process temperature using other lamps 222. The lamps 222 may generate a light to heat the wafer W. The light from the lamps 222 may be provided in a pulse signal form, and an interval between the pulses of the light may be equal to or less than several milliseconds. The wafer W may be warped to have a concave shape and/or a convex shape due to a thermal expansion of the wafer W during the annealing process. As such, the wafer W may vibrate during the annealing process. In an exemplary embodiment, the lamps 242 may continuously apply heat to the wafer W while the lamps 222 operate to heat the wafer W to the process temperature.

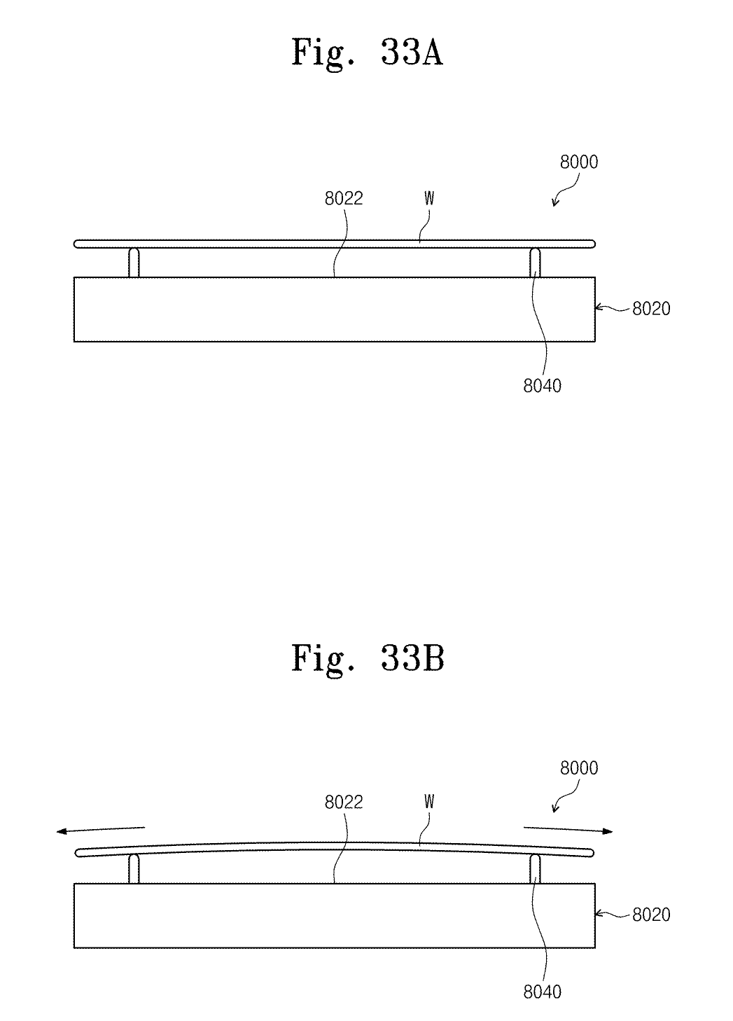

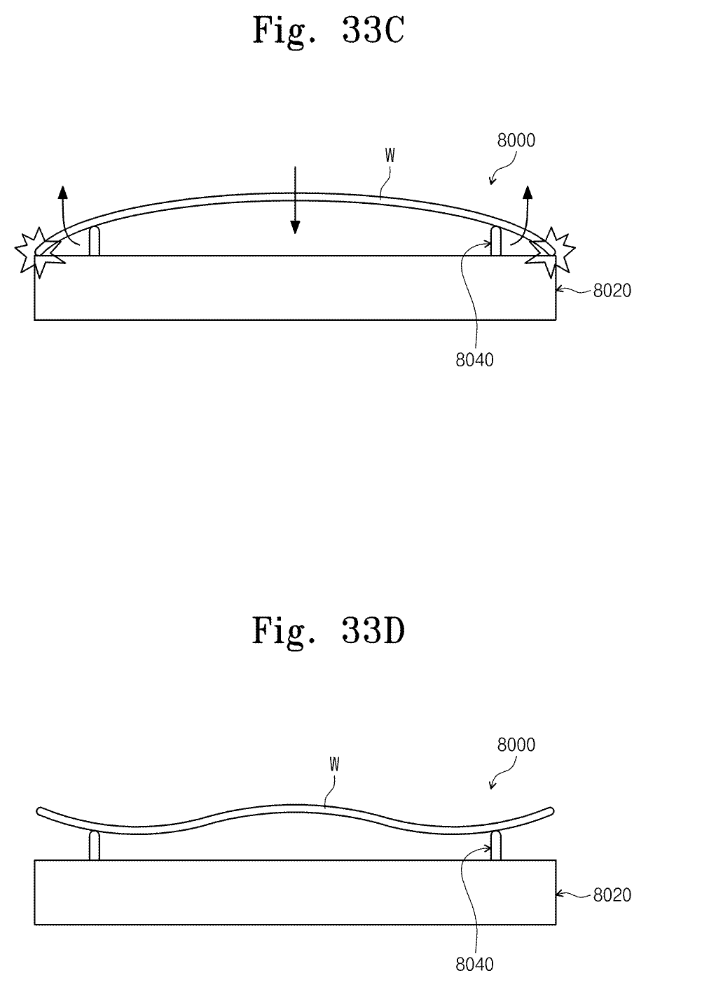

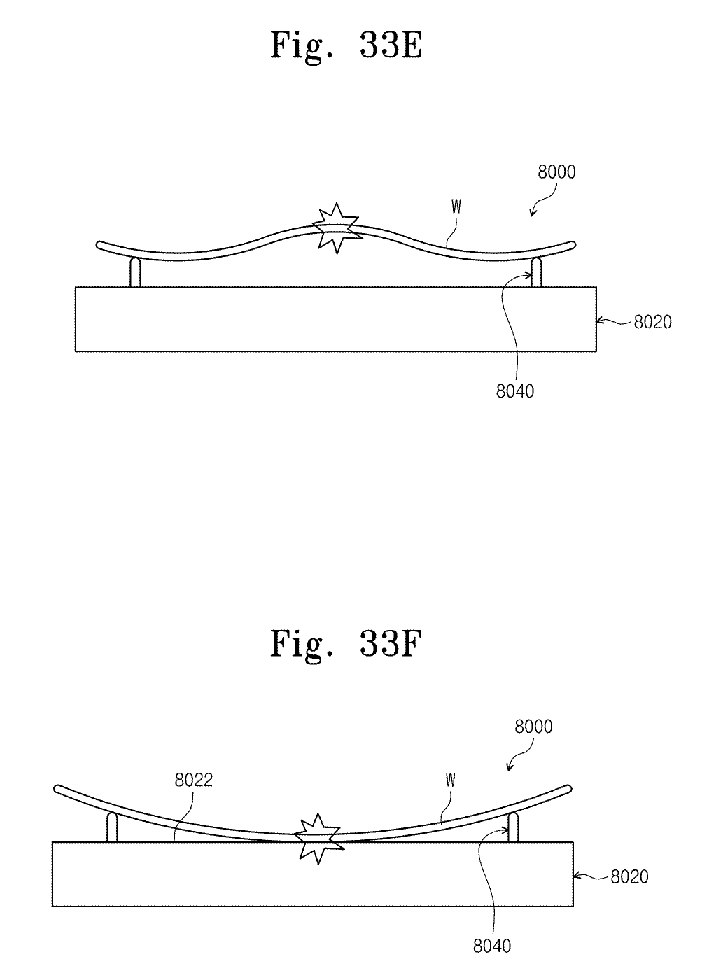

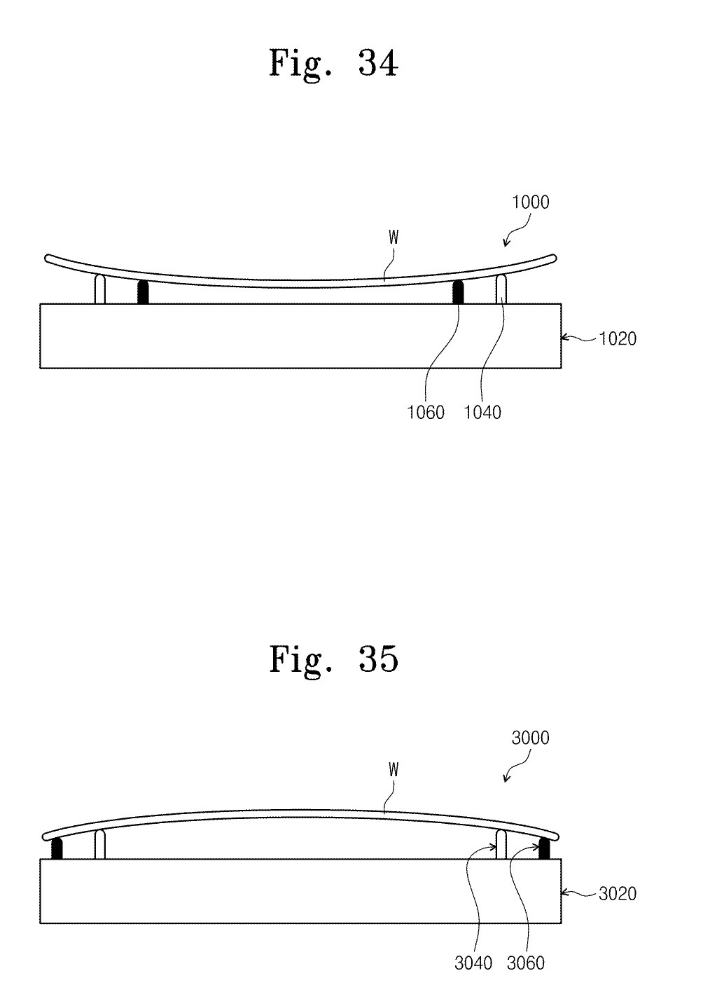

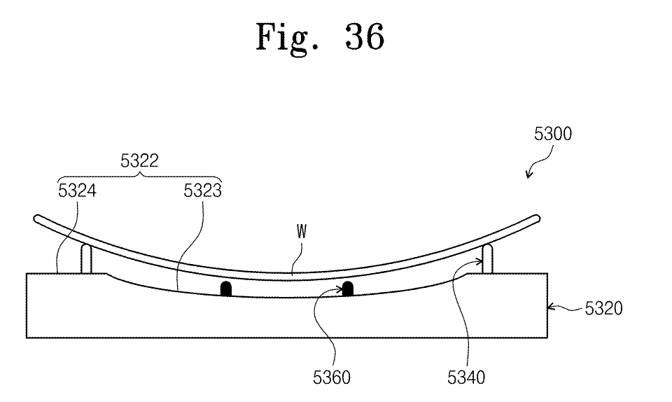

FIGS. 33A to 33F, 34, 35 and 36 are schematic views illustrating warped states of wafers W. As shown in FIGS. 33A to 33F, wafer W becomes warped when annealing processes are performed using supporting unit 8000. FIGS. 33A to 33F illustrate the warped state of the wafer W when the supporting unit 8000 having no auxiliary pins is used in the annealing process. The supporting unit 8000 includes a plate 8020 with a flat top surface 8022 and supporting pins 8040. By contrast, FIG. 34 illustrates the warped state of the wafer W when the supporting unit 1000 shown in FIG. 3 is used in the annealing process, and FIG. 35 illustrates the warped state of the wafer W when the supporting unit 3000 shown in FIG. 16 is used in the annealing process. Further, FIG. 36 illustrates the warped state of the wafer W when the supporting unit 5300 shown in FIG. 16 is used in the annealing process.

Referring to FIGS. 33A to 33F, the wafer W may be deformed in order of FIGS. 33A, 33B, 33C, 33D and 33E. Alternatively, the wafer W may be deformed in order of FIGS. 33A, 33B, 33C, 33D and 33F. Hereinafter, deformation processes of the wafer W will be described. First, the wafer W may be put on the supporting pins 8040 of the supporting unit 8000 (refer to FIG. 33A). The wafer W may be then heated by lamps (222 of FIG. 1). In this case, the wafer W may be thermally expanded to convexly warp, as illustrated in FIG. 33B. Thus, the edge of the wafer W may collide with a top surface 8022 of the plate 8020 (refer to FIG. 33C). If the wafer W strongly collides with the plate 8020, the wafer W may be broken due to a physical impact. Further, a bottom surface of the wafer W may be heated to a temperature of about 700° C. to about 1000° C. during the annealing process, and the top surface 8022 of the plate 8020 may be heated to a temperature of about 200° C. to about 300° C. during the annealing process. Thus, even though the wafer W and the plate 8020 merely contact each other without any strong collision, the wafer W may be easily broken or cracked due to a temperature difference between the wafer W and the plate 8020. Further, even though the wafer W is not broken or cracked, the edge of the wafer W may upwardly warp due to a physical impact generated when the wafer W and the plate 8020 are in contact with each other (refer to FIG. 33D). Consequently, the wafer W may be deformed so that a central region of the wafer W convexly warps and the edge of the wafer W upwardly extends. That is, the wafer W may be deformed to have a ‘W’ shaped vertical sectional view, as illustrated in FIG. 33D. In addition, the physical impact may be concentrated at the central region of the wafer W, thereby breaking or damaging the wafer W (refer to FIG. 33E). Alternatively, after the wafer W may be deformed to have the ‘W’ shaped vertical sectional view illustrated in FIG. 33D, the central region of the wafer W may concavely warp. In this case, the central region of the wafer W may be in contact with or collide with the top surface 8022 of the plate 8020, and the wafer W may be broken or cracked due to a thermal impact or a physical impact (refer to FIG. 33F).

In the event that the supporting unit 1000 of FIG. 3 is used in the annealing process, the auxiliary pins 1060 of the supporting unit 1000 may contact the wafer W to prevent the central region of the wafer W from being in contact with or colliding with the plate 1020 as illustrated in FIG. 34 even though the wafer W is deformed to become concave. Moreover, in the event that the supporting unit 3000 of FIG. 16 is used in the annealing process, the auxiliary pins 3060 of the supporting unit 3000 may contact the wafer W to prevent the edge of the wafer W from being in contact with or colliding with the plate 3020 as illustrated in FIG. 35 even though the wafer W is deformed to become convex. Furthermore, in the event that the supporting unit 5300 of FIG. 30 is used in the annealing process, the concave portion 5323 and the auxiliary pins 5360 on the concave portion 5323 may prevent the central region of the wafer W from being in contact with or colliding with the plate 5320 as illustrated in FIG. 36 even though the wafer W is deformed to become severely concave.

According to the exemplary embodiments set forth above, a supporting unit may be designed to include auxiliary pins and/or a plate with a concave top surface. That is, the supporting pins and/or the concave top surface of the plate may prevent a wafer from being broken or damaged during an annealing process. Therefore, the annealing process may be efficiently performed due to the presence of the auxiliary pins and/or the plate having the concave top surface.

While the inventive concept has been described with reference to exemplary embodiments, it will be apparent to those skilled in the art that various changes and modifications may be made without departing from the spirit and scope of the inventive concept. Therefore, it should be understood that the above exemplary embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A substrate treatment apparatus comprising:
a chamber in which a substrate is processed;
a supporting unit that is disposed in the chamber and is configured to support the substrate; and
a heating member that is configured to apply heat to the substrate supported by the supporting unit,
wherein the supporting unit comprises:
a plate;
a plurality of supporting pins upwardly protruding from the plate; and
at least one auxiliary pin upwardly protruding from the plate,
wherein a distance between a central point of the plate and the at least one auxiliary pin is different from a distance between the central point of the plate and the supporting pins.

2. The substrate treatment apparatus of claim 1, wherein top surfaces of the supporting pins are located at a different level from a top surface of the at least one auxiliary pin.

3. The substrate treatment apparatus of claim 1, wherein top surfaces of the supporting pins have a different shape from a top surface of the at least one auxiliary pin.

4. The substrate treatment apparatus of claim 1, wherein top surfaces of the supporting pins are located at a higher level than a top surface of the at least one auxiliary pin, and
wherein the top surface of the at least one auxiliary pin is flat.

5. The substrate treatment apparatus of claim 1, wherein a top surface of the auxiliary pin has a sloped shape.

6. The substrate treatment apparatus of claim 1, wherein a vertical central axis of the auxiliary pin is tilted with respect to the plate.

7. The substrate treatment apparatus of claim 1, wherein a number of the at least one auxiliary pin is different from that a number of the supporting pins.

8. The substrate treatment apparatus of claim 1, wherein the supporting pins are arrayed in a circular ring,
wherein the at least one auxiliary pin comprises a plurality of auxiliary pins, and the auxiliary pins are arrayed in another circular ring, and
wherein the auxiliary pins are disposed to be out of straight lines connecting a central point of the plate to the supporting pins.

9. The substrate treatment apparatus of claim 1, wherein the at least one auxiliary pin comprises a plurality of auxiliary pins, and
wherein at least one of the auxiliary pins has a different height from the other auxiliary pins.

10. The substrate treatment apparatus of claim 1, wherein the plate includes a central region having a concave top surface.

11. The substrate treatment apparatus of claim 10, wherein the plate includes an edge having a flat top surface,
wherein the supporting pins are provided on the flat top surface, and
wherein the at least one auxiliary pin is provided on the concave top surface.

12. The substrate treatment apparatus of claim 11, wherein a top surface of the at least one auxiliary pin is located at a lower level than the flat top surface.

13. The substrate treatment apparatus of claim 1, wherein the heating member comprises a flash lamp that is disposed over the supporting unit and in the chamber to provide a light in a pulse signal form,
wherein the apparatus further comprises an upper window disposed between the flash lamp and the supporting unit, and wherein a light emitting from the flash lamp permeates the upper window.

14. A supporting unit for supporting a substrate, the supporting unit comprising:
a plate;
a plurality of supporting pins upwardly protruding from the plate; and
at least one auxiliary pin upwardly protruding from the plate,
wherein a distance between a central point of the plate and the at least one auxiliary pin is different from a distance between the central point of the plate and the supporting pins, and
wherein an external shape of the at least one auxiliary pin is different from that of the supporting pins after the at least one auxiliary pin and the supporting pins are installed on the plate.

15. The supporting unit of claim 14, wherein a top surface of the at least one auxiliary pin is located at a different level from top surfaces of the supporting pins.

16. A supporting unit of claim 14, wherein top surfaces of the supporting pins have a different shape from a top surface of the at least one auxiliary pin.

17. A supporting unit of claim 14, wherein top surfaces of the supporting pins have a different shape from a top surface of the at least one auxiliary pin.

18. A supporting unit of claim 14, wherein the plate includes a central region having a concave top surface.

19. A supporting unit of claim 18, wherein the plate includes an edge having a flat top surface,
wherein the supporting pins are provided on the flat top surface, and
wherein the at least one auxiliary pin is provided on the concave top surface.

20. A substrate treatment apparatus comprising:
a chamber in which an annealing process is performed on a wafer;
a plate provided in the treatment space;
a plurality of supporting pins that upwardly protrude from the plate and support the wafer during the annealing process;
a heater that heats the wafer that is supported by the supporting pins; and
means for preventing the wafer that is supported by the supporting pins from coming into contact with the plate due to thermal deformation of the wafer during the annealing process.
